(19) United States
(12) Patent Application Publication
(10) Pub. No.: US 2009/0016765 A1
(43) Pub. Date: Jan. 15, 2009

(54) Image Forming Device and Image Forming Method

(75) Inventor: Mitsunobu Honda, Ikoma-shi (JP)

Correspondence Address: Robert C. Faber;OSTROLENK, FABER, GERB & SOFFEN, LLP, 1180 Avenue of the Americas, New York, NY, 10036-8403, US

(73) Assignee: Kycera Mita Corporation, Osaka (JP)

(21) Appl. No.: 12/170,790

(22) Filed: Jul. 10, 2008

(30) Foreign Application Priority Data
Jul. 12, 2007 (JP) P2007-183364
Jul. 12, 2007 (JP) P2007-183365
Jul. 12, 2007 (JP) P2007-183366

(51) Int. Cl. G03G 21/20

(52) U.S. Cl. 399/94

(57) ABSTRACT

An image forming device including: a fixing unit that fixes a toner image formed on a recording medium by heating the toner image to a temperature that is higher than the softening point of a toner that forms the toner image; and a cooling unit that cools the fixed toner image from a temperature that is higher than the softening point of the toner, to a temperature that is lower than the softening point of the toner, at a predetermined cooling speed.

### BACKGROUND OF THE INVENTION

Priority is claimed on Japanese Patent Application No. 2007-183364, filed on Jul. 12, 2007, Japanese Patent Application No. 2007-183365, filed on Jul. 12, 2007, and Japanese Patent Application No. 2007-183366, filed on Jul. 12, 2007, the contents of which are incorporated herein by reference.

1. Field of the Invention

The present invention relates to an image forming device in which a toner image is formed on a recording medium using an electrophotography, for example, and the image is formed by fixing the toner. The present invention further relates to an image forming method.

2. Description of Related Art

In an image forming device employing electrophotography, for example, a toner image formed on a photosensitive body is transferred to an intermediate transfer body, after which the toner image is transferred to a paper sheet (the aforementioned recording medium) which is passes between the intermediate transfer body and a transfer roller. By then heating and melting the toner, the transferred toner image is heat fixed to the recording medium.

Methods for heat fixing a toner image to a recording medium may be broadly classified into contact and non-contact methods. Examples of contact methods include heat roller fixing, belt fixing, and film fixing, among others. Examples of non-contact methods, on the other hand, include flash fixing, oven fixing, and the like. From among these, a contact method employing heat roller fixing is most typically employed as thermal efficiency is high due to direct contact between the toner image and the heat roller, and the size of the device can be decreased.

However, in contact methods employing heat roller fixing, an offset phenomenon, in which melted toner remains on the heat roller after the recording medium has passed through the heat roller, tends to occur readily.

Various methods have been proposed for limiting formation of this offset phenomenon, including a method in which silicon oil or other such release agents which have high releasability is coated to the surface of the heat roller, or a method in which wax is kneaded (dispersed) inside the toner and the surface of the toner is covered with the wax which melts during heating. However, the use of wax dispersion techniques in particular have increased greatly in the field of toner manufacturing employing polymer methods in recent years, as they permit a decrease in device size and a reduction in maintenance. Oil-free fixing methods in which wax is dispersed in toner have accordingly become the mainstream.

Further, with the spread of color images, the requirements for image forming devices with respect to image quality have become more diverse. For example, the production of posters or high quality magazines requires an extremely high level image quality (i.e., high gloss images, etc.) that is difficult to accomplish with images formed using conventional electrophotography methods.

However, when heated toner (melted toner) cools to room temperature, the resins included in the toner shrink during the cooling process. As a result, a shrink mark can form on the surface of the image, resulting in a deterioration in the smoothness of the image surface and producing an image with reduced gloss.

Due to its ability to provide high gloss images, there has been an increase in demand in recent years for a paper sheet in which surface irregularities have been reduced and for a coated paper sheet which is highly thermal conductive in which a coating has been applied to fill and smooth surface irregularities.

As a method for obtaining a high gloss image, Japanese Patent Application, First Publication No. H4-195079 (referred to as “Reference No. 1” hereinafter) discloses an image forming device that permits control in a heat belt fixing method to select between a non-gloss mode in which fixing is carried out at the fixing temperature, and a gloss mode in which fixing is carried out at a temperature which is higher than that in the non-gloss mode, for example.

In addition, Japanese Patent Application, First Publication No. 2005-250335 (referred to as “Reference 2” hereinafter) discloses an image forming device that includes a cooling unit for cooling around the melting temperature of the wax, wherein the toner image is rapidly cooled near the melting temperature of the wax contained in the toner image. In this image forming device, where the melting temperature of the wax is taken to be 80 to 85° C., the toner image is brought into contact with a cooling roller (metal roller) when the toner image surface temperature is 88° C. The toner image is rapidly cooled from 88° C. to 76° C. as a result, which limits crystallization of the wax. Opacification of the wax layer that coats the image surface is thereby prevented, thus increasing gloss.

Japanese Patent Application, First Publication No. 2003-208047 (referred to as “Reference 3” hereinafter) discloses an image forming method that rapidly cools the toner image using a cooling device composed of a heat pipe, a driven roller, and an insulating member. In this image forming method, image roughness (granular appearance) is improved by limiting changes in volume and area following fixing of the toner image.

Japanese Patent Application, First Publication No. 2003-21978 (referred to as “Reference 4” hereinafter) discloses an image forming device that is equipped with an air blowing device for cooling the toner image which has a plurality of air blow holes located between the fixing device and the conveying roller. In this image forming device, air is blow out to cool the toner image and the recording medium, thus preventing formation of low gloss areas.

However, in the case of the image forming device disclosed in Reference No. 1, the gloss will vary depending on whether the toner is completely melted or a portion remains in the granular state. For this reason, it is difficult to increase gloss further in this device with the toner being completely melted.

In addition, wax has the effect of increasing gloss by creating a mirrored surface when it is coated very finely to the surface of a melted toner. Since gloss depends on surface reflectivity, it is therefore not possible to sufficiently improve gloss simply by controlling opacification of the wax layer as disclosed in Reference No. 2.

The image forming method disclosed in Reference No. 3 is a method for preventing a dot image or line image defacement, which occurs when a toner image formed on a paper sheet is held by a conveying roller during a state of high toner temperature. As a result, it is difficult to obtain the effect of sufficient gloss improvement in solid image areas. Further, the change in volume after fixing of the toner image is prescribed to 30% and the change in area after fixing of the toner image is prescribed to 20%. However, these values vary based on heating conditions, fixing pressure and quantity of toner applied, and are not dependent on toner properties. Accordingly, even if the changes in volume and area are prescribed, it is difficult to improve such toner surface properties as image gloss or luster.

In the image forming device disclosed in Reference No. 4, the fixing device which is adjacent to the air blowing device employed to cool the toner image tends to be cooled by the air as well. As a result, excess electrical power is required, and temperature deviations can occur along the axial direction of the heat roller which is provided to the fixing device. In addition, warm air around the fixing device is dispersed within the image forming device, causing variation in the sensitivity of the photosensitive body as well as changes in the charge of the developing agent. Accordingly, this leads to a deterioration in the image.

The present invention was conceived in view of the above-described circumstances and has a first object of providing an image forming device, as well as an image forming method, for forming a high gloss image in which the smoothness of the image surface has been improved without causing a deterioration in the image.

Further, the present invention has a second object of providing an image forming device, as well as an image forming method, for controlling cracking which occurs on the image surface and forming a high gloss image.

### SUMMARY OF THE INVENTION

In order to achieve the above-described objects, the present invention employs the following. Namely, an image forming device according to the present invention includes: a fixing unit that fixes a toner image formed on a recording medium by heating the toner image to a temperature that is higher than the softening point of a toner that forms the toner image; and a cooling unit that cools the fixed toner image from a temperature that is higher than the softening point of the toner, to a temperature that is lower than the softening point of the toner, at a predetermined cooling speed.

It may be arranged such that the cooling speed is 150 to 250° C./sec.

It may be arranged such that the cooling unit includes a cooling roller.

It may be arranged such that the cooling unit includes a first cooling roller that cools the toner image by contacting the toner image, and a second cooling roller that is opposite the first cooling roller; and the surface temperature of the first cooling roller is controlled so as to be higher than the surface temperature of the second cooling roller.

It may be arranged such that the first cooling roller and the second cooling roller are controlled so as to be pressed into contact with each other or separated from each other; and the first cooling roller and the second cooling roller are pressed into contact with each other when the recording medium passes between the first cooling roller and the second cooling roller, such that the recording medium is held therebetween.

It may be arranged such that the cooling unit includes a misting nozzle that sprays a liquid as a mist onto the toner image.

Further, an image forming method according the present invention includes: fixing a toner image formed on a recording medium by heating the toner image to a temperature that is higher than the softening point of a toner that forms the toner image; and cooling the fixed toner image from a temperature that is higher than the softening point of the toner, to a temperature that is lower than the softening point of the toner, at a predetermined cooling speed.

It may be arranged such that the cooling speed is 150 to 250° C./sec.

It may be arranged such that the fixed toner image is cooled by passing between a first cooling roller and a second cooling roller that is opposite the first cooling roller while being brought into contact with the first cooling roller; and the surface temperature of the first cooling roller is controlled so as to be higher than the surface temperature of the second cooling roller.

It may be arranged such that the first cooling roller and the second cooling roller are controlled so as to be pressed into contact with each other or separated from each other; and the first cooling roller and the second cooling roller are pressed into contact with each other when the recording medium passes between the first cooling roller and the second cooling roller, such that the recording medium is held therebetween.

It may be arranged such that the image forming method further includes cooling the toner image by spraying a liquid as a mist.

The above-described image forming device and image forming method enable improvement in the smoothness of the image surface and an increase in gloss without leading to deterioration of the image. As a result, it is possible to obtain a high quality image, i.e., the first object of the present invention can be achieved.

In addition, it is possible to limit cracking which occurs in the image surface, and to obtain a high quality image with increased gloss, i.e., the second object of the present invention can be achieved.

By employing the above image forming device and image forming method, the essential vivid hues of deep colors can be obtained, making it particularly ideal for color images.

Further, when rapidly cooling the toner image, the temperature of the discharged paper can be reduced since the recording medium is also cooled.

### BRIEF DESCRIPTION OF THE DRAWINGS

FIG. 1 is a schematic structural view showing the image forming device according to the first embodiment of the present invention.

FIG. 2 is a schematic structural view showing the fixing unit and the cooling unit of the image forming device according to the embodiment.

FIG. 3 is a side view showing the misting nozzle of the image forming device according to the embodiment.

FIG. 4 is a schematic structural view showing the image forming device according to the second embodiment of the present invention.

FIG. 5 is a schematic structural view showing the fixing unit and the cooling unit of the image forming device according to the embodiment.

FIG. 6 is a side view of the cooling unit shown in FIG. 5.

FIG. 7 is a schematic structural view showing the image forming device according to the third embodiment of the present invention.

FIG. 8 is a schematic structural view showing the fixing unit and the cooling unit of the image forming device according to the embodiment.

FIG. 9 is a side view of the cooling unit shown in FIG. 8.

FIG. 10 is a planar view of the second cooling roller shown in FIG. 9.

### DETAILED DESCRIPTION OF THE INVENTION

The first embodiment of the present invention will now be explained in detail with reference to the figures.

FIG. 1 is a schematic structural view showing the image forming device according to the first embodiment of the present invention. The image forming device 100 according to the first embodiment is provided roughly at its center with an image forming part 110. The image forming part 110 is provided with a photosensitive drum 11, as well as a charging unit 12 disposed to the periphery of the photosensitive drum 11, an exposing unit 13, a developing unit 14, a transferring unit 15, a cleaning blade 16 and a roller 17. A fixing unit 18 is provided downstream to the photosensitive drum 11 in the direction of conveyance of the recording medium (paper), and a cooling unit 19 for cooling the toner image is disposed downstream to the fixing unit. A paper supplier 120 is provided below the image forming device 100, and a paper supply roller 121 is disposed downstream to the paper supplier 120 in a paper supply direction. Further, a paper discharge unit 130 for expelling the recording medium 122 after the image is formed is disposed above the image forming device 100.

An electrostatic latent image is formed on the surface of the photosensitive drum 11. It is preferable to employ an amorphous silicon photosensitive body for the photosensitive drum 11. This amorphous silicon photosensitive body is formed by sequentially laminating onto a conductive substrate a carrier injection preventing layer consisting of Si:H:B:O or the like; a carrier excitation/transport layer (photoconductive layer) consisting of Si:H or the like; and a surface protecting layer consisting of SiC:H or the like.

The charging unit 12 is disposed above the photosensitive drum 11 and uniformly charges the photosensitive drum 11.

The exposing unit 13 forms an electrostatic latent image onto the photosensitive drum 11 based on the original image that is read out from the image date input member (not shown in the figures).

The developing unit 14 forms a toner image by supplying toner to the surface of the photosensitive drum 11 where the electrostatic image has been formed. The developing unit 14 is provided with a rotary rack 141, and a plurality of developers 14Y, 14M, 14C, 14K. The rotary rack 141 is rotated about its rotational axis 140 by a rotating unit (not shown in the figures), and carries out developing by moving the plurality of developers 14Y, 14M, 14C, 14K in sequence to the developing position against the photosensitive drum. The yellow developer 14Y, magenta developer 14M, cyan developer 14C and black developer 14K are maintained in alignment in this order about the circumferential direction of the rotary rack 141. Further, these developers are disposed so that the interval between adjacent developers along the periphery is approximately 90 degrees.

The transferring unit 15 is for transferring the toner image on the photosensitive drum 11 to the recording medium, and is provided with an intermediate transfer belt 151, primary transfer rollers 152 and 153, a drive roller 155, a secondary transfer opposing roller 154, and a secondary transfer roller 156. The intermediate transfer belt 151 is endlessly wrapped around the primary transfer rollers 152 and 153, the drive roller 155, and the secondary transfer opposing roller 154, and is driven by the drive roller 155. The intermediate transfer belt 151 functions as a transfer body to which the toner image formed on the photosensitive drum 11 is transferred and temporarily held. The secondary transfer roller 156 is disposed to a position opposite the secondary transfer opposing roller 154 at the outer peripheral surface of the intermediate transfer belt 151, and function in the secondary transfer of the toner image to the recording medium.

The cleaning blade 16 is for cleaning adherents such as leftover developing agent that remains on the photosensitive drum 11. For example, a urethane rubber with a hardness of 77° is pressed into contact with the photosensitive drum.

The roller 17 comes into contact with the surface of the photosensitive drum 11, and functions as a buffer which recovers or blows off toner. The roller 17 is formed by covering the circumference of a metal shaft with foaming rubber, and is biased at 9.8 N (each side: 4.9 N) toward the photosensitive drum 11 by springs (not shown in the figures). In addition, the roller 17 is in contact with the photosensitive drum 11 and has a surface speed during rotation that is 1.2 times that of the surface speed of the drum.

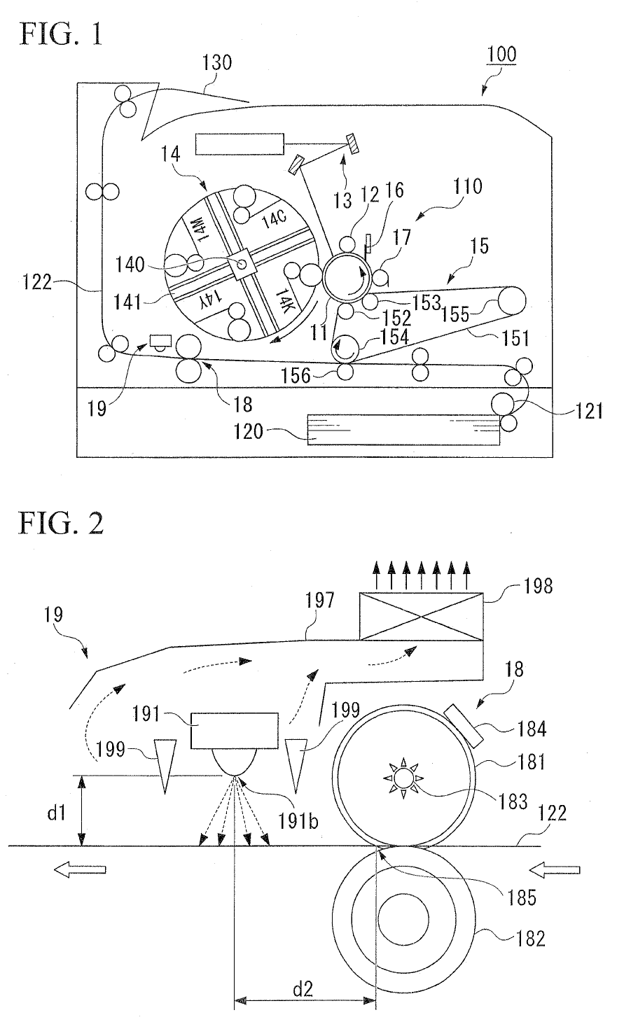

As shown in FIG. 2, the fixing unit 18 is formed of a fixing roller (heat roller) 181 which is a fixing body disposed to be freely rotating; a pressure roller 182 which is a pressing body that rotates while pressing against the fixing roller 181. A heater 183 such as a halogen lamp or the like is disposed inside the fixing roller 181. In addition, a thermistor 184 is disposed so as to be in contact with the fixing roller 181 in order to measure its surface temperature. Based on the value measured with the thermistor 184, a temperature adjusting circuit carries out adjustment of the temperature of the surface of the fixing roller 181 by controlling the voltage of the heater 183. With this arrangement in place, when the conveyed recording medium 122 passes between the pressure roller 182 and the fixing roller 181 which is rotating at a fixed speed, the recording medium 122 is subjected to pressing and heating at a constant pressure and temperature on both its front and back surfaces. As a result, the unfixed toner image on the surface of the recording medium 122 is melted and fixed thereto. As a result, a full color image is formed on the recording medium 122.

The recording medium 122 to which the image has been fixed is separated from the fixing roller 181 with a separating claw (not shown), and expelled to the outside of the device.

As the fixing roller 181 that is employed in the above-described fixing unit 18, it is preferable to employ a design in which, for example, a material having superior releasability, thermal resistance, and wear resistance, such as a fluorinated resin or the like, is coated to the surface of an aluminum or other such metal pipe, forming an outer layer thereto. In the case where the image forming device is one in which image quality is particularly emphasized, such as a color copying machine that employs an electrophotography, it is preferable to employ silicon rubber as the outer layer of the roller in the fixing roller 181. However, silicon rubber has somewhat poorer releasability as compared to fluorinated resins, so that it is desirable to coat a silicon oil to the surface thereof as a releasing agent. Note that it is acceptable to employ a product in which a fluorinated resin sheet has been wrapped to a silicon rubber.

The pressure roller 182 is not particularly restricted, however, it is preferable to employ a silicon rubber roller having a solid metal rod as a core.

As shown in FIG. 2, the cooling unit 19 is provided with a misting nozzle 191 that blows out a liquid in mist form onto the toner image.

The cooling unit 19 rapidly cools the toner image by spraying the liquid as a mist onto the toner image which has been heated at the fixing unit 18.

The misting nozzle 191 is not particularly restricted, provided that it is able to spray a liquid in the form of extremely small diameter particles. A dual flow nozzle may be preferably employed, for example.

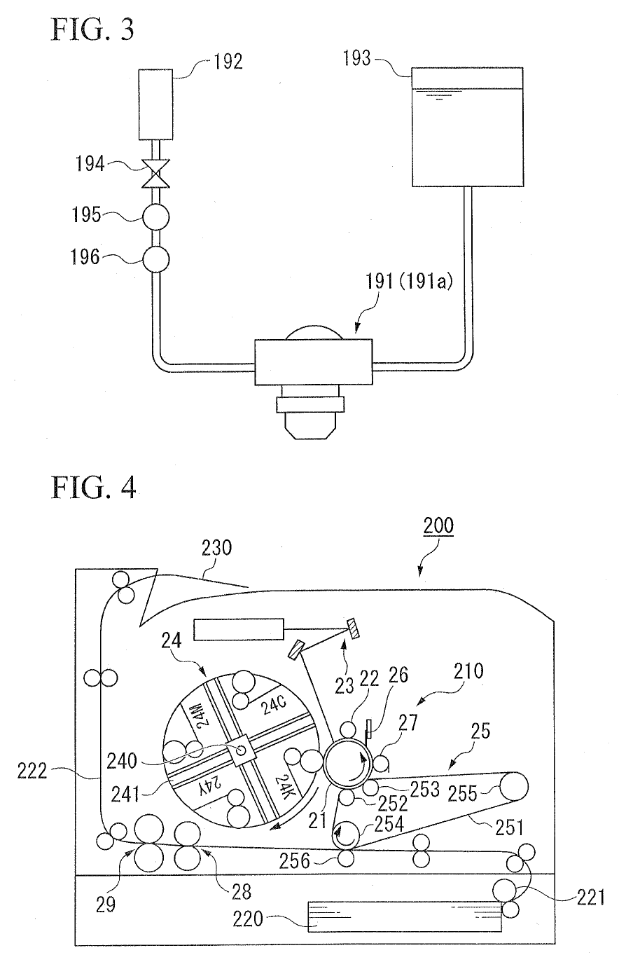

A dual flow nozzle is one in which liquid and air are made to collide, causing the liquid to be formed into particles having a diameter ranging from several μm to several tens μm, with these particles then sprayed together with the air. As shown in FIG. 3, the dual nozzle 191a may be employed with an attached air pump 192 and tank 193, for example.

The liquid employed is not particularly restricted provided it is one which does not have an effect on the toner image. Water, however, is preferably employed. More specifically, distilled water is preferred from the perspective of preventing blockage of the mixing nozzle 191. Further, provided that it does not have an effect on the toner image, use of a solvent such as alcohol which has excellent volatility enables effective cooling of the toner image.

A conventionally known design may be employed for the dual flow nozzle 191a, with the Air Atomizing Nozzle ¼ J Series manufactured by Spraying Systems Co., Japan cited as a suitable example thereof, for example.

Note that the air pump 192 is attached to the dual flow nozzle 191a via, in sequence, a ball valve 194, an electromagnetic valve 195, and a regulator 196. Specifically, by providing a regulator 196, the air pressure can be adjusted so that the amount of misty liquid spray that is sprayed out from the dual nozzle 191a can be controlled. Note that if the spray amount is fixed, then it is possible to exchange the regulator 196 for a small size regulator that is not provided with an adjusting knob or meter.

It is preferable to set the air pressure to 0.02 to 0.15 MPa, with a range of 0.05 to 0.10 MPa being even more preferable. When the air pressure is less than 0.02 MPa, the liquid flow rate increases too much, and there is a tendency for the recording medium to absorb the liquid. On the other hand, if the air pressure exceeds 0.15 MPa, then the liquid flow rate falls, and it becomes difficult to expel adequate liquid.

The quantity of liquid sprayed can be controlled by adjusting the air pressure. For example, it is preferable to adjust the air pressure so that the quantity of liquid sprayed per unit time is 0.001 mL/cm² or more, and more preferably, 0.005 mL/cm². When the quantity of liquid sprayed per unit time is less than 0.001 mL/cm², it is difficult to sufficiently cool the toner image.

The quantity of liquid sprayed increases as the air pressure decreases. When the quantity of liquid sprayed increases, the amount of misty liquid adhering to the recording medium 122, not only to the area where the toner image is formed, but also to areas where there is no toner image formed, increases. In general, when a paper sheet (i.e., the recording medium) comes into contact with liquid, the paper bends, or creasing occurs. However, when the amount of liquid sprayed from the typical dual flow nozzle is calculated for a single A4 sized piece of paper, for example, it is difficult for the amount of liquid sprayed to reach a quantity sufficient to cause paper bending or creasing. Further, since the liquid is blown onto the toner image after being rendered into mist form, not all of this liquid adheres to the toner image or the recording medium. Rather, a portion of the liquid evaporates before reaching the toner image and the recording medium. Accordingly, while there is no particular restriction on the upper limit of the amount of liquid sprayed, it is preferable to set this value to 0.01 mL/cm² or less from the perspective of conserving energy.

Known methods may be cited as examples of methods for supplying the liquid from the tank 193 to the misting nozzle 191, including a gravity water supply method, a compression pump method, a siphon method, etc. From among these, it is preferable to employ the gravity supply method to supply liquid to the mixing nozzle 191 due to cost, ease of supply of the liquid, and the wide parameters for adjusting the flow rate.

It is preferable to dispose the misting nozzle 191 so that the distance d1 shown in FIG. 2 from the nozzle opening 191b to the toner image on the recording medium 122 is in the range of 10 to 30 mm. In addition, it is preferable that the misting nozzle 191 is disposed so that the distance d2 from the exit of the fixing nip part to the nozzle opening 191b is in the range of 20 to 50 mm. Further, it is preferable to set the mixing nozzle 191 so that the liquid is sprayed as a mist perpendicular to the toner image.

The fixing nip part refers to the area of contact between the fixing roller 181 and the pressure roller 182 in the direction of conveyance of the recording medium 122. The exit of the fixing nip part refers to the end part 185 on the cooling unit 19 side of the fixing nip part.

In the present embodiment, the number of misting nozzles 191 is not particularly restricted provided that the spray region of the misting nozzles 191 satisfies the width of the recording medium 122. Namely, it is acceptable to provide one misting nozzle, or to provide a plurality of misting nozzles. When a plurality of misting nozzles 191 are provided, then a number in the range of 5 to 15 is preferred. In addition, the arrangement of the misting nozzles is not particularly restricted, as long as the total of the spray regions of each of the misting nozzles satisfies the width of the recording medium 122. However, a single row arrayed in the width direction of the recording medium 122 is preferred.

Note that when a plurality of misting nozzles 191 are provided, it is acceptable to provide an air pump 192 and a tank 193 for each of the misting nozzles, or to provide one air pump 192 and tank 193 for all the misting nozzles.

As described above, when a heated toner image is cooled, the resin included in the toner shrinks during the cooling process, and a shrink mark can readily form on the surface of the image. In particular, there are marked volume changes around the softening point of the toner, and shrinkage of the resin occurs readily. In addition, when the toner image undergoes gradual cooling around its softening point, then the resin more easily shrinks. Smoothness of the image surface decreases when a shrink mark forms, making it difficult to obtain a high gloss image.

In addition, when a contact-type cooling unit such as a metal roller or heat pipe is employed in cooling the toner image, the toner image is brought into contact with the cooling unit, and the recording medium on which that toner image is cooled while being conveyed. As a result, irregularities on the surface of the contact-type cooling unit are transferred to the toner image on the recording medium. Image deterioration can thus occur. A pushing force is applied to the surface of the toner image due to bringing a contact-type cooling unit into contact with the toner image, causing cracking.

In contrast, in the present embodiment, it possible to limit shrinkage of the resin that is included in the toner by rapidly cooling the toner image. As a result, the smoothness of the image surface improves and a high gloss image can be obtained.

The toner image is cooled by spraying a liquid as a mist in the present embodiment. Thus, the toner image can be cooled without bringing the cooling unit into direct contact with the toner image. Accordingly, image deterioration due to transfer of the irregularities in the surface of the cooling unit to the image does not readily occur. The cooling unit employed in the present embodiment is a non-contact type, so that a pressing force is not applied to the surface of the toner image. Thus, cracks arising from the pressing force do not readily occur.

Note that the dispersing area of the misty liquid is narrow as compared to air. Thus, cooling of the fixing unit adjacent to the cooling unit does not occur as readily as in the case where the toner image is cooled using air. As a result, it is possible to control energy consumption.

In the present embodiment, when the misty liquid from the misting nozzle is sprayed, rapidly cooling the toner image, it is preferable to rapidly cool the toner image from a temperature that is higher than the softening point of the toner, to a temperature that is lower than the softening point (i.e., it is preferable to carry out rapid cooling at temperatures near the toner softening point). Specifically, the cooling speed of the toner image near the softening point of the toner is preferably in the range of 150 to 250° C./sec. When the cooling speed is less than 150° C./sec, cooling is not sufficient and it tends to become difficult to control resin shrinkage. In contrast, when the cooling speed is greater than 250° C./sec, cracking in the image surface can occur.

By rapidly cooling the toner image around the toner softening point, it is possible to effectively control resin shrinkage and to obtain an even higher gloss image.

Note that it is preferable that the surface temperature of the toner image after passing through the spray region of the misting nozzle be 10 to 35° C. less than the softening point of the toner.

As shown in FIG. 2, a recovery duct 197 for recovering the liquid sprayed out from the misting nozzle 191 is provided to the cooling unit 19 above the misting nozzle 191. A fan 198 is connected to the front end of the recovery duct 197. By driving the fan 198, air flow is generated so as to guided liquid along the recovery duct 197. As a result, the misty liquid which is not adhered to the toner image and the recording medium can be recovered by the recovery duct 197. Thus, it is possible to prevent dewing inside the image forming device, and rusting of metal parts. Further, by generating air flow, the liquid adhered to the toner image and the recording medium can be readily evaporated.

As shown in FIG. 2, temperature sensors 199 may be provided to the cooling unit 19 at positions before and after the misting nozzle 191, so that the surface temperature of the toner image on the recording medium 122 can be measured before and after the recording medium 122 passes through the spray region of the misting nozzle 191.

A non-contact type thermometer may be used as the temperature sensor 199.

Next, the image forming method according to the present embodiment will now be explained using the image forming device 100 shown in FIG. 1.

First, charging of the photosensitive drum 11 using the charging unit 12 is carried out, after which the rotary rack 141 rotates about the rotational axis 140 provided at its center. The rotary rack 141 stops at the developing position, which is the position where the developer 14K, corresponding to black which is the first color, is opposite the photosensitive drum 11. Light exposure corresponding to black is then carried out by the exposing unit 13, and an electrostatic latent image corresponding to black is formed on the surface of the photosensitive drum 11. This electrostatic latent image then undergoes toner imaging by the developer 14K, and the toner image which is formed on the surface of the photosensitive drum 11 is transferred to the transfer belt 151 by the transfer bias which is applied on the primary transfer rollers 152 and 153.

When this formation of the black toner image to the transfer belt 151 is complete, the rotary rack 141 rotates around the rotational axis 140 provided at its center, and the developer 14C corresponding to cyan is positioned at the developing position. This operation is carried out for the other colors of cyan, magenta, and yellow respectively, to form the full color toner image on the transfer belt 15.

As described above, during the process of temporarily transferring the toner image to the intermediate transfer belt 151, the secondary transfer roller 156 separates from the transfer belt 151. In contrast, when the full color toner image is formed on the transfer belt 151, the secondary transfer roller 156 comes into contact with the transfer belt 151. At this time, by applying the secondary transfer bias with the secondary transfer roller 156, the full color toner image that is formed on the transfer belt 151 is transferred to the recording medium 122 which has been conveyed from the paper supplier 120 to the transfer position by the paper supply roller 121, etc., at a specific timing.

Next, the full color toner image transferred to the recording medium is fixed to the recording medium 122 by applying heat and pressure from the fixing unit as shown in FIG. 2. The heating temperature of the toner is acceptable provided that it is higher than the softening point of the toner. However, a temperature that is 25 to 45° C. higher than the softening point of the toner is preferable.

When the recording medium 122 is conveyed to the cooling unit 19, the misty liquid from the misting nozzle 191 is sprayed in accompaniment with the passage of the recording medium 122, and the toner image heated by the fixing unit 18 is rapidly cooled. The cooling speed is preferably in the range of 150 to 250° C./sec, and it is preferable that distilled water be employed as the liquid.

Next, the recording medium 122 is expelled to the paper discharge unit 130 shown in FIG. 1. Note that the liquid adhered to the toner image and the recording medium 122 is immediately evaporated by cooling the heated toner and the recording medium.

The leftover developing agent that remains in the photosensitive drum 11 is cleaned by the cleaning blade 16, and is discarded in a waste toner container (not shown in the figures). The toner that remains in the transfer belt 151 is cleaned by bringing a cleaning device (not shown in the figures) for the transfer belt 151 into contact with the transfer belt 151 after the secondary transfer, and discarding the toner in the waste toner container (not shown in the figures). After the transfer belt 151 cleaning device has cleaned a portion of the transfer belt 151, it is separated from the transfer belt 151.

As explained above, in the above embodiment, the toner image is rapidly cooled, so that shrinkage of the resin included in the toner can be limited. As a result, the smoothness of the image surface can be improved, making it possible to obtain a high gloss image.

Since the toner image is cooled by spraying liquid as a mist in the present embodiment, the toner image can be cooled without bringing a cooling unit directly into contact with the toner image. Accordingly, image deterioration due to transfer of the irregularities in the surface of the cooling unit does not readily occur. In addition, the cooling unit employed in the present embodiment is a non-contact type, so that a pressing force is not applied to the surface of the toner image. Thus, the cracks that arise due to this pressing force to do not readily occur.

In the present embodiment, it is possible to obtain the essential vivid hues of deep colors, making it particularly ideal for forming color images.

When rapidly cooling the toner image, the recording medium (paper) also cools, so that the temperature of the expelled paper can be reduced.

Since the smoothness of the image surface is improved, the stacking properties of the expelled paper are also improved.

Note that the dispersing area of the misty liquid is narrow as compared to air. Accordingly, in the present embodiment, the fixing unit that is adjacent to the cooling unit does not readily cool as compared to the case where the toner image is cooled using the air. Accordingly, the energy consumption of the fixing unit is controlled, and it is possible control the temperature variation along the axial direction of the fixing roller that is equipped to the fixing unit. In addition, there is little dispersion of the warm around the fixing unit within the image forming device, so that image deterioration due to changes in the sensitivity of the photosensitive drum or changes in the charge of the developing agent does not readily occur.

The above-described first embodiment of the present invention will be concretely explained citing examples.

### [Toner Production]

Two parts by weight of the polymerization initiator 2,2-azo-bis (2,4-dimethylvaleronitrile) was added to a mixed solution of 80 parts by weight of styrene, 20 parts by weight of 2-ethylhexylmethacrylate, 5 parts by weight of cyan pigment (C.I. pigment blue 15:3) employed as a coloring agent, 3 parts by weight of low molecular weight polypropylene, 2 parts by weight of a quaternary ammonium compound ([P-51], manufactured by Orient Chemical Industries, Ltd.) employed as the charge control agent, and 1 part by weight of divinyl benzene employed as a cross-linking agent. This mixture was added to 400 parts by weight of purified water. Five parts by weight of tricalcium phosphate and 0.1 parts by weight of sodium dodecylbenzenesulphonate were then added as a suspension stabilizer. A TK homomixer (manufactured by Tokushu Kika Kogyo Co., Ltd.) was employed to stir the mixture for 20 minutes at a rotation speed of 7000 rpm. The mixture was then allowed to polymerize and react for 10 hours at 100 rpm and 70° C. under a nitrogen atmosphere, to obtain a powder having a volume average particle diameter of 6.3 μm. Hydrophobic silica powder was added to this powder in the amount of 1.5 parts by weight. This was then mixed using a Hensel mixer (manufactured by Mitsui Mining Co., Ltd.), to obtain a cyan toner having a volume average particle diameter of 6.3 μm. The volume average particle diameter was measured using a Multisizer-III (manufactured by Beckman Coulter, Inc.).

The electric charge of the obtained cyan toner was measured using a draw-off type charge measuring device (manufactured by Trek, Inc.), and was 33 μC/g.

### (Measurement of Softening Point)

The softening point of the obtained cyan toner was measured with a flow tester (CFT-500A, manufactured by Shimadzu Corporation), and was 117° C.

Specifically, the sample for measurement was obtained by compressing 1.5 g of cyan toner into a cylindrical shape having a diameter of 1 cm at a pressure of 16 MPa. Using this sample, the softening point was defined as the temperature at which one half of the sample had flowed off under the conditions of an extrusion pressure of 1.2732 MPa, a rate of temperature increase of 6° C./minute, a die diameter of 1.0 mm, and a die length of 1.0 mm.

### EXAMPLES 1 to 6

### <Structure of Image Forming Device>

An image forming device having the structure shown in FIGS. 1 to 3 was employed, and a toner obtained in advance was housed in the developer. The design of the fixing unit 18 and the cooling unit 19 are as follows.

### (Fixing Unit)

For the fixing roller 181, a design was employed in which 200 μm thick silicon rubber having a hardness of 5 (JIS-A) was coated to the surface of a 1.0 mm thick aluminum tube having an outer diameter of φ30 mm, after which a 30 μm thick PFA (a copolymer of tetrafluoroethylene and perfluoralkoxyethylene) tube was adhered via a primer to the surface of the above coated aluminum tube. A halogen heat lamp 183 was disposed inside the fixing roller 181, and lighting of the lamp was controlled so that the surface temperature of the fixing roller was a constant 170° C. according to a thermistor 184 that was in contact with the surface of the fixing roller 181.

For the pressure roller 182, a solid iron rod having a core with an outer diameter of φ18 mm was employed for the core of the silicon rubber having a thickness of 6 mm, a hardness of 5 (JIS-A) and an outer diameter of φ30 mm.

### (Cooling Unit)

For the misting nozzle 191, a design was employed in which a liquid cap (PF2050, manufactured by Spraying Systems Co., Japan) and an air cap (PA67-6-20-70°, manufactured by Spraying Systems Co., Japan) were attached to the main body of a dual flow nozzle (Air Atomizing Nozzle ¼ J, manufactured by Spraying Systems Co., Japan).

Five of these nozzles were prepared, and were arrayed in a single row along the width direction of the recording medium 122 so that the distance d1 from the nozzle opening 191b to the toner image on the recording medium 122 was 20 mm, and the distance d2 from the exit of the fixing nip part to the nozzle opening 191b was 30 mm (i.e., at a position 0.2 seconds downstream from the exit of the fixing nip part when the recording medium conveying speed is 150 mm/sec).

The five nozzles were attached so as to share tank 193 which held distilled water. A ball valve was attached to each of the nozzles, and all of the nozzles shared one air pump 192.

### <Evaluation>

The following measurements were carried out employing an image forming device in which distilled water was sprayed from the misting nozzle 191 to cool the toner image.

In each of the embodiments, the air pressure of the misting nozzle 191 was adjusted so as to have the values shown in Table 1, and image samples were collected while recording the surface temperature of the toner image before and after (measuring interval was 38 mm=0.25 sec) passing through the spray region of the misting nozzle. Color copy paper with a weight of 90 g/m², A4 size, manufactured by Mondi was employed as the recording medium. The amount of toner on the recording medium was 1.5 mg/cm², and the surface temperature of the toner image before passing through the spray region of the misting nozzle was 140° C. At an air pressure of 0.05 MPa, the amount of distilled water sprayed during the passage of the recording medium through the spray region of the misting nozzle was 12 mL, where the medium width was 210 mm (A4), the system speed was 150 mm/sec, the amount of distilled water sprayed with a single nozzle was 1.7 mL at 0.05 MPa, and the number of the nozzles are five.

The surface temperature of the toner image after passing through the spray region of the misting nozzle, the cooling speed by the cooling unit, and the image surface glossiness of the image sample, for the 200^{th} piece of printed paper are shown in Table 1. The cooling speed and glossiness were obtained as follows.

### (Cooling Speed)

The cooling speed was calculated using Equation (1) below.

Cooling speed[° C./sec]=1 (surface temperature of the toner image before passing through the spray region of the misting nozzle)−(surface temperature of the toner image after passing through the spray region of the misting nozzle)}/0.25 (1)

### (Glossiness)

The image surface glossiness of the image samples was measured using a gloss meter (Handy Gloss Checker IG-331, manufactured by Horiba Ltd., angle of incidence: 60°). A glossiness of 30 or greater was considered acceptable.

### Comparative Example 1

With the exception that a misting nozzle was not provided, images were formed and evaluated in the same manner as in Examples 1 to 6. These results are shown in Table 1.

TABLE 1

| | | | Surface temp. | | |
|---|---|---|---|---|---|
| | | | of toner image | | |
| | | | after passing | | |
| | | Toner | through | | |
| | Air | softening | spray region | Cooling | |
| | pressure | temp. | of misting | speed | |
| | (MPa) | (° C.) | nozzle (° C.) | (° C./sec) | Glossiness |
| Ex. 1 | 0.05 | 117 | 58.9 | 324 | 32 |
| Ex. 2 | 0.065 | 117 | 73.5 | 266 | 33 |
| Ex. 3 | 0.08 | 117 | 87.7 | 209 | 45 |
| Ex. 4 | 0.095 | 117 | 99.1 | 164 | 43 |
| Ex. 5 | 0.11 | 117 | 111.1 | 116 | 30 |
| Ex. 6 | 0.125 | 117 | 122.3 | 71 | 30 |
| Comp. | No spray | 117 | 135 | 20 | 28 |
| Ex. 1 | nozzle | | | | |
| | provided | | | | |

As is clear from Table 1, the images obtained in each of the various Examples all had higher glossiness than the Comparative Examples due to rapid cooling of the toner. In particular, in the case where the air pressure was less than 0.095 MPa (Examples 1 to 4), a high gloss was clear on visual inspection, and the image obtained was of a high quality not typically obtainable without using coated paper. In the case of Examples 1 to 4, shrinkage of the resin contained in the toner was effectively limited by rapid cooling of the toner image from a temperature higher than, to a temperature lower than, the softening point (117° C.) of the cyan toner employed in these examples. As a result, it can be assumed that the smoothness of the image surface and the glossiness were further improved. However, in the case of Examples 1 and 2, the cooling speed was faster than that of Examples 3 and 4 (i.e., due to cooling to a temperature that was more than 40° C. below the softening point of the cyan toner), so that slight cracking in the image surface occurred. As a result, the glossiness was lower than that of Examples 2 and 3.

In contrast, distilled water was not sprayed in Comparative Example 1, so that there was almost no cooling of the toner image. As a result, the glossiness was inferior as compared to the Examples.

The image surface of the image samples obtained in the various Examples and Comparative Examples was inspected using a digital microscope (VHX-600, manufactured by Keyence Corp., 1000 to 2000 magnification). In the case of the Examples, this inspection revealed very slightly depressed spots. As the glossiness became greater, the size of the spots became smaller, with a finer interval and a shallower depth. In addition, since the toner was rapidly cooled by blowing misted distilled water in the Examples (i.e., the toner image was cooled by a non-contact-type cooling unit), irregularities in the surface of the cooling unit were not transferred to the toner image, as would be the case where a contact-type cooling unit, such as a cooling roller, is employed.

In contrast, as compared to the Examples, larger spots with greater intervals and deeper depressions were seen in the Comparative Examples.

The second embodiment of the present invention will now be explained in detail with reference to the figures.

FIG. 4 is a schematic structural view showing the image forming device according to the second embodiment of the present invention. The image forming device 200 according to the second embodiment is provided roughly at its center with an image forming part 210. The image forming part 210 is provided with a photosensitive drum 21, as well as a charging unit 22 disposed to the periphery of the photosensitive drum 21, an exposing unit 23, a developing unit 24, a transferring unit 25, a cleaning blade 26 and a roller 27. A fixing unit 28 is provided downstream to the photosensitive drum 21 in the direction of conveyance of the recording medium (paper), and a cooling unit 29 for cooling the toner image is disposed downstream to the fixing unit. A paper supplier 220 is provided below the image forming device 200, and a paper supply roller 221 is disposed downstream to the paper supplier 220 in a paper supply direction. Further, a paper discharge unit 230 for expelling the recording medium 222 after the image is formed is disposed above the image forming device 200.

An electrostatic latent image is formed on the surface of the photosensitive drum 21. It is preferable to employ an amorphous silicon photosensitive body for the photosensitive drum 21. This amorphous silicon photosensitive body is formed by sequentially laminating onto a conductive substrate a carrier injection preventing layer consisting of Si:H:B:O or the like; a carrier excitation/transport layer (photoconductive layer) consisting of Si:H or the like; and a surface protecting layer consisting of SiC:H or the like.

The charging unit 22 is disposed above the photosensitive drum 21 and uniformly charges the photosensitive drum 21.

The exposing unit 23 forms an electrostatic latent image onto the photosensitive drum 21 based on the original image that is read out from the image date input member (not shown in the figures).

The developing unit 24 forms a toner image by supplying toner to the surface of the photosensitive drum 21 where the electrostatic image has been formed. The developing unit 24 is provided with a rotary rack 241, and a plurality of developers 24Y, 24M, 24C, 24K. The rotary rack 241 is rotated about its rotational axis 240 by a rotating unit (not shown in the figures), and carries out developing by moving the plurality of developers 24Y, 24M, 24C, 24K in sequence to the developing position against the photosensitive drum. The yellow developer 24Y, magenta developer 24M, cyan developer 24C and black developer 24K are maintained in alignment in this order about the circumferential direction of the rotary rack 241. Further, these developers are disposed so that the interval between adjacent developers along the periphery is approximately 90 degrees.

The transferring unit 25 is for transferring the toner image on the photosensitive drum 21 to the recording medium, and is provided with an intermediate transfer belt 251, primary transfer rollers 252 and 253, a drive roller 255, a secondary transfer opposing roller 254, and a secondary transfer roller 256. The intermediate transfer belt 251 is endlessly wrapped around the primary transfer rollers 252 and 253, the drive roller 255, and the secondary transfer opposing roller 254, and is driven by the drive roller 255. The intermediate transfer belt 251 functions as a transfer body to which the toner image formed on the photosensitive drum 21 is transferred and temporarily held. The secondary transfer roller 256 is disposed to a position opposite the secondary transfer opposing roller 254 at the outer peripheral surface of the intermediate transfer belt 251, and function in the secondary transfer of the toner image to the recording medium.

The cleaning blade 26 is for cleaning adherents such as leftover developing agent that remains on the photosensitive drum 21. For example, a urethane rubber with a hardness of 77° is pressed into contact with the photosensitive drum.

The roller 27 comes into contact with the surface of the photosensitive drum 21, and functions as a buffer which recovers or blows off toner. The roller 27 is formed by covering the circumference of a metal shaft with foaming rubber, and is biased at 9.8 N (each side: 4.9 N) toward the photosensitive drum 21 by springs (not shown in the figures). In addition, the roller 27 is in contact with the photosensitive drum 21 and has a surface speed during rotation that is 1.2 times that of the surface speed of the drum.

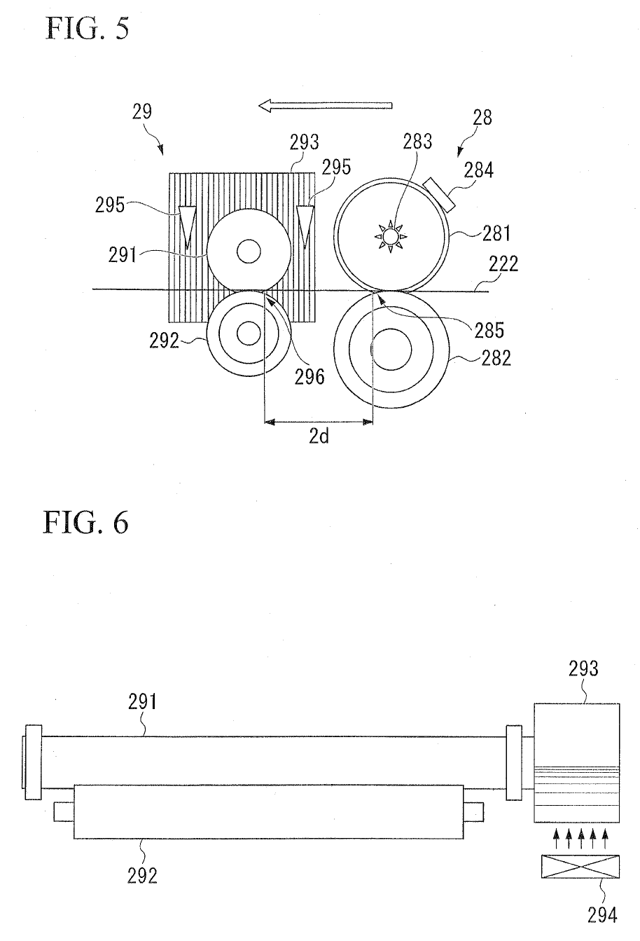

As shown in FIG. 5, the fixing unit 28 is formed of a fixing roller (heat roller) 281 which is a fixing body disposed to be freely rotating; a pressure roller 282 which is a pressing body that rotates while pressing against the fixing roller 281. A heater 283 such as a halogen lamp or the like is disposed inside the fixing roller 281. In addition, a thermistor 284 is disposed so as to be in contact with the fixing roller 281 in order to measure its surface temperature. Based on the value measured with the thermistor 284, a temperature adjusting circuit carries out adjustment of the temperature of the surface of the fixing roller 281 by controlling the voltage of the heater 283. With this arrangement in place, when the conveyed recording medium 222 passes between the pressure roller 282 and the fixing roller 281 which is rotating at a fixed speed, the recording medium 222 is subjected to pressing and heating at a constant pressure and temperature on both its front and back surfaces. As a result, the unfixed toner image on the surface of the recording medium 222 is melted and fixed thereto. As a result, a full color image is formed on the recording medium 222.

The recording medium 222 to which the image has been fixed is separated from the fixing roller 281 with a separating claw (not shown), and expelled to the outside of the device.

As the fixing roller 281 that is employed in the above-described fixing unit 28, it is preferable to employ a design in which, for example, a material having superior releasability, thermal resistance, and wear resistance, such as a fluorinated resin or the like, is coated to the surface of an aluminum or other such metal pipe, forming an outer layer thereto. In the case where the image forming device is one in which image quality is particularly emphasized, such as a color copying machine that employs an electrophotography, it is preferable to employ silicon rubber as the outer layer of the roller in the fixing roller 281. However, silicon rubber has somewhat poorer releasability as compared to fluorinated resins, so that it is desirable to coat a silicon oil to the surface thereof as a releasing agent. Note that it is acceptable to employ a product in which a fluorinated resin sheet has been wrapped to a silicon rubber.

The pressure roller 282 is not particularly restricted, however, it is preferable to employ a silicon rubber roller having a solid metal rod as a core.

As shown in FIG. 5, the cooling unit 29 is provided with a cooling roller 291 that is a cooling body disposed in a manner to permit free rotation, and a conveying roller 292 which is a conveying body that rotates while applying pressure on the cooling roller 291, and conveys the recording medium 222.

The cooling unit 29 rapidly cools the toner image heated by the fixing unit 28, from a temperature which is higher than the toner softening point to a temperature which is lower than the toner softening point (i.e., that rapidly cools at temperatures around the toner softening point).

When the heated toner image is cooled, the resin contained in the toner shrinks during the cooling process, and shrink marks can readily form on the surface of the image. The change in volume is marked around the softening point of the toner, so that shrinkage of the resin most readily occurs around this temperature. When the toner image is gradually cooled around the softening point of the toner, resin shrinkage occurs more readily. When a shrink mark forms, the smoothness of the image surface decreases, and it becomes difficult to obtain a high gloss image.

However, by cooling the toner image rapidly around the softening point of the toner in the present embodiments, shrinkage of the resin contained in the toner can be limited. As a result, the smoothness of the image surface is improved and a high gloss image can be obtained.

The cooling speed of the toner image around the softening point of the toner is preferably in the range of 150 to 250° C./sec, and more preferably 150 to 230° C./sec. When the cooling speed is less than 150° C./sec, cooling is not sufficient and it tends to become difficult to control resin shrinkage. In contrast, when the cooling speed is greater than 250° C./sec, cracking in the image surface can occur.

Note that it is preferable that the surface temperature of the toner image after passing through the cooling roller 291 be 10 to 35° C. less than the softening point of the toner.

A heat pipe (made of copper), for example, may be preferably employed as the cooling roller 291. A heat pipe is superior with respect to thermal transmission, making it possible to rapidly cool the toner by means of direct contact with the toner image. However, since the adhesiveness between a copper heat pipe and the toner is low, variation within the cooling speed may occur. As a result, non-uniformity can readily occur in the obtained image. A PFA (copolymer of tetrafluoroethylene and perfluoralkoxyethylene) sheet is therefore adhered via a primer to the surface of the heat pipe. As a result, it is also possible to ensure separation with the melted toner. The thickness of the PFA sheet is preferably on the order of 30 μm in the case of a heat pipe having an outer diameter of φ20 mm. In addition, it is also acceptable to adhere silicon rubber in place of the PFA sheet.

It is preferable to employ the heat pipe after injecting it with a cooling medium. Examples of a cooling medium include alternative Freon; an ammonia cooling medium; isobutane, methanol, ethanol or other hydrocarbons; water; and the like.

By using the cooling roller 291 described above in the present embodiment, it is possible to cool the toner image without using air or the like. As a result, the adjacent fixing unit 28 does not readily cool as compared to the case where air is employed. Accordingly, power consumption at the fixing unit 28 can be controlled, and temperature deviation along the axial direction of the fixing roller 281 provided to the fixing unit 28 can be reduced. In addition, dispersing of the warm air from around the fixing unit 28 within the image forming device is limited, so that image deterioration due to changes in sensitivity of the photosensitive drum 21 or changes in the charge of the developing agent does not readily occur.

Further, as shown in FIG. 6, the end of the cooling roller 291 is extended beyond the paper feeding region, and attached to a radiator fin 293. A fan 294 is provided directly below the radiator fin 293. The cooling medium that is injected into the cooling roller 291 is cooled inside the radiator fin 293. Accordingly, the temperature of the surface of the cooling roller 291 can be maintained around the ambient temperature +3° C., even in the case where continuously feeding paper.

A silicon rubber roller, for example, can be used as the conveying roller 292. The conveying roller 292 is pressed by the cooling roller 291 with a pressing force of 29.4 N (one side).

Heat from the conveying roller 292 is removed by the cooling roller 291 via the recording medium 222, so that active cooling is not necessary.

The area of disposition of the cooling roller 291 and the conveying roller 292 is not particularly restricted provided that it is a distance that does not permit the toner temperature after fixing to fall to a value near the toner softening point by natural cooling. For example, it is preferable to dispose the cooling roller 291 and the conveying roller 292 so that the distance 2d from the exit of the fixing nip part to the entrance of the cooling nip part is in the range of 10 to 50 mm.

As shown in FIG. 5, the term “fixing nip part” as used here refers to the area of contact between the fixing roller 281 and the pressure roller 282. The exit of the fixing nip part is the end 285 of the fixing nip part on the cooling unit 29. As shown in FIG. 5, the term “cooling nip part” refers to the area of contact between the cooling roller 291 and the conveying roller 292 in the direction of conveyance of the recording medium 222. The entrance of the cooling nip part is the end 296 of the cooling nip part on the fixing unit 28 side.

As shown in FIG. 5, a temperature sensor 295 may be provided before and after the cooling roller 291 in the cooling unit 291, so that the surface temperature of the toner image on the recording medium 222 can be measured before and after passing through the cooling roller 291.

For example, a non-contact type thermometer may be employed as the temperature sensor 295.

Next, the image forming method according to the present embodiment will now be explained using the image forming device 200 shown in FIG. 4.

First, charging of the photosensitive drum 21 using the charging unit 22 is carried out, after which the rotary rack 241 rotates about the rotational axis 240 provided at its center. The rotary rack 241 stops at the developing position, which is the position where the developer 24K, corresponding to black which is the first color, is opposite the photosensitive drum 21. Light exposure corresponding to black is then carried out by the exposing unit 23, and an electrostatic latent image corresponding to black is formed on the surface of the photosensitive drum 21. This electrostatic latent image then undergoes toner imaging by the developer 24K, and the toner image which is formed on the surface of the photosensitive drum 21 is transferred to the transfer belt 251 by the transfer bias which is applied on the primary transfer rollers 252 and 253.

When this formation of the black toner image to the transfer belt 251 is complete, the rotary rack 241 rotates around the rotational axis 240 provided at its center, and the developer 24C corresponding to cyan is positioned at the developing position. This operation is carried out for the other colors of cyan, magenta, and yellow respectively, to form the full color toner image on the transfer belt 25.

As described above, during the process of temporarily transferring the toner image to the intermediate transfer belt 251, the secondary transfer roller 256 separates from the transfer belt 251. In contrast, when the full color toner image is formed on the transfer belt 251, the secondary transfer roller 256 comes into contact with the transfer belt 251. At this time, by applying the secondary transfer bias with the secondary transfer roller 256, the full color toner image that is formed on the transfer belt 251 is transferred to the recording medium 222 which has been conveyed from the paper supplier 220 to the transfer position by the paper supply roller 221, etc., at a specific timing.

Next, the full color toner image transferred to the recording medium is fixed to the recording medium 222 by applying heat and pressure from the fixing unit as shown in FIG. 5. The heating temperature of the toner is acceptable provided that it is higher than the softening point of the toner. However, a temperature that is 25 to 45° C. higher than the softening point of the toner is preferable.

The toner image heated by the fixing unit 28 is rapidly cooled from a temperature that is higher than the softening temperature of the toner to a temperature that is lower than the softening temperature of the toner (i.e., to a temperature near the softening temperature of the toner) by the cooling unit 29. The cooling speed is preferably 150 to 250° C./sec, and more preferably 150 to 230° C./sec.

The recording medium 222 is subsequently expelled to the paper discharge unit 230 shown in FIG. 4.

The leftover developing agent that remains in the photosensitive drum 21 is cleaned by the cleaning blade 26, and is discarded in a waste toner container (not shown in the figures). The toner that remains in the transfer belt 251 is cleaned by bringing a cleaning device (not shown in the figures) for the transfer belt 251 into contact with the transfer belt 251 after the secondary transfer, and discarding the toner in the waste toner container (not shown in the figures). After the transfer belt 251 cleaning device has cleaned a portion of the transfer belt 251, it is separated from the transfer belt 251.

As explained above, by rapidly cooling the toner image to a temperature near the softening point of the toner in the above-described embodiment, it is possible to limit shrinkage of the resin included in the toner. As a result, the smoothness of the image surface can be improved, and a high gloss image can be obtained.

Further, the essential vivid hues of deep colors can be obtained in the above-described embodiment, making it particularly ideal for color images.

When the toner image is rapidly cooled, the recording medium (paper) is also cooled, thus reducing the temperature of the expelled paper.

The smoothness of the image surface is improved, so that the stacking properties of the expelled paper are also improved.

Note that air was not used in the cooling unit in the present embodiment, so that the fixing unit that is next to the cooling unit does not readily cool. Accordingly, power consumption by the fixing unit can be reduced, and deviations in the temperature along the axial direction of the fixing roller that is provided to the fixing unit can be reduced. In addition, very little of the warm air from around the fixing unit is dispersed within the image forming device, so that image deterioration due to changes in the sensitivity of the photosensitive drum and changes in the charge of the developing agent does not readily occur.

The above-described second embodiment of the present invention will be concretely explained by citing examples thereof.

### [Production of Toner A]

The toner A which is used in the present examples was produced by the same sequence as the toner in the example of the above-described first embodiment.

### [Measurement of Softening Point]

The softening point of the obtained toner A was measured with a flow tester (CFT-500A, manufactured by Shimadzu Corporation), and was found to be 117° C.

Specifically, the sample for measurement was obtained by compressing 1.5 g of toner A into a cylindrical shape having a diameter of 1 cm at a pressure of 16 MPa. Using this sample, the softening point was defined as the temperature at which one half of the sample had flowed off under the conditions of an extrusion pressure of 1.2732 MPa, a rate of temperature increase of 6° C./minute, a die diameter of 1.0 mm, and a die length of 1.0 mm.

### [Production of Two Component Developing Agent]

### <Production of Binder Resin>

A monomer solution consisting of 70 parts by weight of styrene and 30 parts by weight of butyl acrylate was dripped over three hours into a solution which contained 6 parts by weight of 2,2′-azo-bis (2,4-dimethylvaleronitrile) (V-65, manufactured by Wako Pure Chemical Industries, Ltd.) as a polymerization initiator and 200 parts by weight of toluene as a solvent (the solution was provided with a condenser and the toluene was refluxed). Following dripping, the mixture was maintained at 60° C. for 12 hours to permit polymerization to take place. The toluene was then removed by distillation under reduced pressure, to obtain binder resin No. 1 for use in the toner.

### <Production of Toner B>

Three parts by weight of a quaternary ammonium compound (P-51, Orient Chemical Industries) as a charge control agent, 4 parts by weight of cyan pigment (PB15-3, Ciba-Geigy K. K.) as a coloring agent, and 5 parts by weight of polyethylene wax (155 Microwax, Nippon Oil Corp.) as a release agent were mixed into binder resin No. 1 using a Hensel mixer. Melt kneading was then carried out using a biaxial extruder, to formulate a resin composition for use in the toner.

The obtained resin composition for use in the toner was finely ground using an air grinding mill, and classified using an air classifier, to obtain toner particles in which the mean particle diameter based on volume was 8 μm.

0.5 parts by weight of hydrophobic silica (TG820, Cabot Corp.) and 0.8 parts by weight of titanium oxide (EC-100T, Titan Kogyo Co.) were added as a surface treating agent to 100 parts by weight of toner particles. This was mixed by high stirring in a Hensel mixer, to obtain Toner B (cyan toner).

### <Production of a Two Component Developing Agent>

Toner B was compounded with a silicon resin coated ferrite carrier (EF-60B, Powder Tech., Inc.) having a mean particle diameter of 80 μm so that the toner concentration reached 5 wt %. This was uniformly mixed by stirring, to obtain a two component developing agent.

### (Measurement of Softening Point)

The softening point of the obtained Toner B was measured with a flow tester (CFT-500A, manufactured by Shimadzu Corporation), and was found to be 110° C.

Note that measurement of the softening point was carried out in the same manner as for Toner A.

### EXAMPLES 7 to 10

### <Structure of Image Forming Device>

For the image forming device, the design shown in FIGS. 4 and 5 was employed after appropriate modification to suit the developing agent. For the developing agent, the previously obtained toner A (cyan toner) was employed and was housed in the developer container. Note that the design of the fixing unit 28 and the cooling unit 29 is as follows below.

### (Fixing Unit)

For the fixing roller 281, a design was employed in which 200 μm thick silicon rubber having a hardness of 5 (JIS-A) was coated to the surface of a 1.0 mm thick aluminum tube having an outer diameter of φ30 mm, after which a 30 μm thick PFA (a copolymer of tetrafluoroethylene and perfluoralkoxyethylene) tube was adhered via a primer to the surface of the above coated aluminum pipe. A halogen heat lamp 283 was disposed inside the fixing roller 281, and lighting of the lamp was controlled so that the surface temperature of the fixing roller was a constant 170° C. with use of a thermistor 284 that was in contact with the surface of the fixing roller 281.

For the pressure roller 282, a solid iron rod having a core with a outer diameter of φ18 mm was employed for the core of the silicon rubber having a thickness of 6 mm, a hardness of 5 (JIS-A) and an outer diameter of φ30 mm.

### (Cooling Unit)

The cooling roller 291 and the conveying roller 292 that is opposite this cooling roller 291 were arrayed so that the distance d2 from the exit of the fixing nip part to the entrance of the cooling nip part was 30 mm (i.e., at a position 0.2 seconds downstream from the exit of the fixing nip part when the recording medium conveying speed is 150 mm/sec).

A silicon rubber roller having a hardness of 5 (JIS-A) and an outer diameter of φ20 mm was employed for the conveying roller 292.

Cooling rollers A to D in which alternative Freon (cooling media) was injected into heat pipes having an outer diameter of φ20 mm were employed for the cooling roller 291. Note that the amount of alternative Freon injected into each of the heat pipes was adjusted so that the surface temperature of the toner image after passing through the cooling roller had the values shown in Table 2.

### <Evaluation>

Using an image forming device to which various cooling rollers were attached, image samples were captured while recording the surface temperature of the toner image before and after passing through the cooling roller (after 38 mm=0.25 sec). The measurements were carried out at positions along the direction of conveyance that were 19 mm upstream and downstream, respectively, from the point of intersection between the straight line connecting the center of rotation of the cooling roller 291 and the center of rotation of the conveying roller 292, and the recording media conveying path. Color copy paper with a weight of 90 g/m², manufactured by Mondi was employed as the recording medium. The amount of toner on the recording medium was 1.5 mg/cm², and the surface temperature of the toner image before passing through the cooling roller was 140° C.

The surface temperature of the toner image after passing through the cooling roller, the cooling speed of the cooling unit, and the image surface glossiness of the image sample, for the 200^{th} piece of printed paper are shown in Table 2. The cooling speed and glossiness were obtained as follows.

### (Cooling Speed)

The cooling speed was calculated using the Equation (2) below.

Cooling speed[° C./sec]={(surface temperature of the toner image before passing through the cooling roller)−(surface temperature of the toner image after passing through the cooling roller)}/0.25 (2)

### (Glossiness)

The image surface glossiness of the image samples were measured using a gloss meter (Handy Gloss Checker IG-331, manufactured by Horiba Ltd., angle of incidence: 60°). Based on the glossiness, an evaluation using the following evaluation standards was then made. Note that evaluation as “excellent” or “good” is considered a passing evaluation.

| | |
|---|---|
| Excellent: | glossiness of 41 or more |
| Good: | glossiness of 31 to 40 |
| Poor: | glossiness of 30 or less |

### EXAMPLE 11

With the exception of employing a two component developing agent produced using toner B as the developing agent, image formation was carried out in the same manner as in Example 8, and evaluated. These results are shown in Table 2.

### EXAMPLE 12

With the exception of employing a two component developing agent produced using toner B as the developing agent, image formation was carried out in the same manner as in Example 9, and evaluated. These results are shown in Table 2.

### Comparative Example 2

With the exception that a cooling roller E, in which alternative Freon is injected into the heat pipe and the amount of alternative Freon injected is adjusted so that the surface temperature of the toner image after passage of the cooling roller becomes the value shown in Table 2, is employed as the cooling roller, image formation was carried out in the same manner as in Examples 7 to 10, and evaluated. These results are shown in Table 2.

### Comparative Example 3

With the exception that a cooling roller was not attached, image formation was carried out in the same way as in Examples 7 to 10, and evaluated. These results are shown in Table 2.

TABLE 2

| | | | | Surface temperature | | | |
|---|---|---|---|---|---|---|---|
| | | | Softening | of toner image after | | | |
| | | | point of | passing through | Cooling speed | | |
| | Cooling roller | Developing agent | toner (° C.) | cooling roller (° C.) | (° C./sec) | Glossiness | |
| Ex. 7 | cooling roller A | toner A | 117 | 74.8 | 261 | 33 | good |
| Ex. 8 | cooling roller B | toner A | 117 | 84.2 | 223 | 45 | excellent |
| Ex. 9 | cooling roller C | toner A | 117 | 99.6 | 162 | 43 | excellent |
| Ex. 10 | cooling roller D | toner A | 117 | 113.5 | 106 | 30 | good |
| Ex. 11 | cooling roller B | Two component | 110 | 83.2 | 227 | 45 | excellent |
| | | system developing | | | | | |
| | | agent (toner B) | | | | | |
| Ex. 12 | cooling roller C | Two component | 110 | 95.6 | 164 | 43 | excellent |
| | | system developing | | | | | |
| | | agent (toner B) | | | | | |
| Comp. | cooling roller E | toner A | 117 | 121.1 | 76 | 29 | good |
| Ex. 2 | | | | | | | |
| Comp. | None | toner A | 117 | 135 | 20 | 28 | good |
| Ex. 3 | | | | | | | |

As is clear from Table 2, the images obtained in each of the various Examples all had higher glossiness than those of the Comparative Examples. In particular, a high gloss was clear on visual inspection, and the image obtained was of a high quality not typically obtainable without using coated paper. In the case of Examples 7 to 12, shrinkage of the resin contained in the toner was effectively limited by rapid cooling of the toner image from a temperature higher than, to a temperature lower than, the softening point (117° C. or 110° C.) of the cyan toner (Toner A or Toner B) obtained in these Examples. As a result, it can be assumed that the smoothness of the image surface and the glossiness were further improved. However, in the case of Example 7, the cooling temperature was faster than that of Examples 8 and 9 (i.e., due to cooling to a temperature that was more than 40° C. below the softening point of the cyan toner), so that cracks in the image surface occurred. As a result, glossiness was lower than that of Examples 8 and 9.

In contrast, in Comparative Example 2, the toner image was not rapidly cooled around the softening point of the cyan toner, so that the glossiness was inferior as compared to the Examples.

Further, in Comparative Example 3, the toner image was hardly cooled at all, so that the glossiness was even more inferior.

The image surface of the image samples obtained in the various Examples and Comparative Examples was inspected using a digital microscope (VHX-600, Keyence Corp., 1000 to 2000 magnification). In the case of the Examples, this inspection revealed very slightly depressed spots. As the glossiness increased, the size of the spots became smaller, with a finer interval and a shallower depth.

In contrast, as compared to the Examples, larger spots with greater intervals and deeper depressions were seen in the Comparative Examples.

The third embodiment of the present invention will now be explained in detail with reference to the figures.

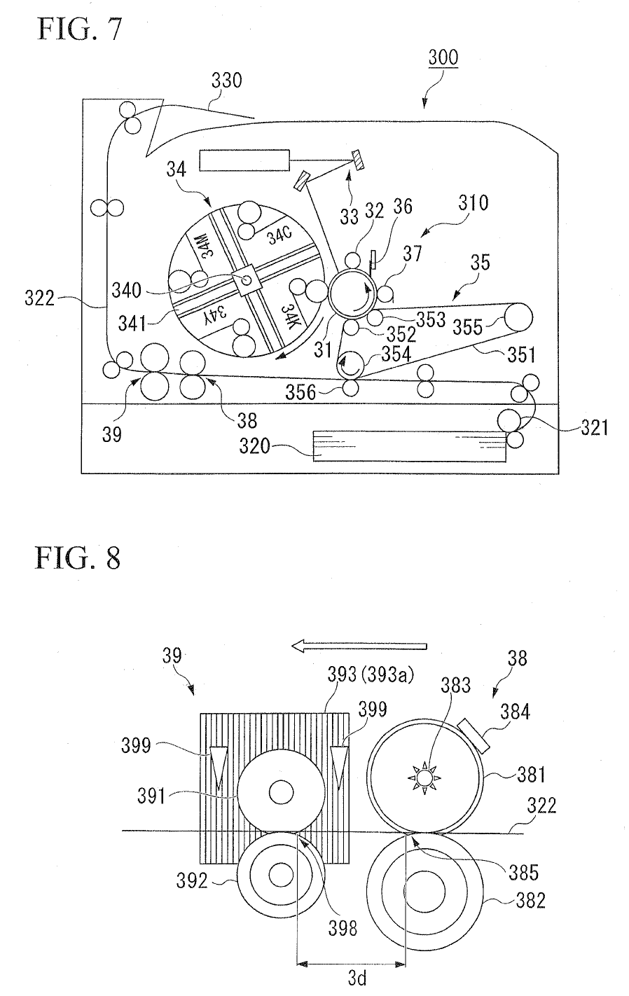

FIG. 7 is a schematic structural view showing the image forming device according to the third embodiment of the present invention. The image forming device 300 according to the third embodiment is provided roughly at its center with an image forming part 310. The image forming part 310 is provided with a photosensitive drum 31, as well as a charging unit 32 disposed to the periphery of the photosensitive drum 31, an exposing unit 33, a developing unit 34, a transferring unit 35, a cleaning blade 36 and a roller 37. A fixing unit 38 is provided downstream to the photosensitive drum 31 in the direction of conveyance of the recording medium (paper), and a cooling unit 39 for cooling the toner image is disposed downstream to the fixing unit. A paper supplier 320 is provided below the image forming device 300, and a paper supply roller 321 is disposed downstream to the paper supplier 320 in a paper supply direction. Further, a paper discharge unit 330 for expelling the recording medium 322 after the image is formed is disposed above the image forming device 300.

An electrostatic latent image is formed on the surface of the photosensitive drum 31. It is preferable to employ an amorphous silicon photosensitive body for the photosensitive drum 31. This amorphous silicon photosensitive body is formed by sequentially laminating onto a conductive substrate a carrier injection preventing layer consisting of Si:H:B:O or the like; a carrier excitation/transport layer (photoconductive layer) consisting of Si:H or the like; and a surface protecting layer consisting of SiC:H or the like.

The charging unit 32 is disposed above the photosensitive drum 31 and uniformly charges the photosensitive drum 31.

The exposing unit 33 forms an electrostatic latent image onto the photosensitive drum 31 based on the original image that is read out from the image date input member (not shown in the figures).

The developing unit 34 forms a toner image by supplying toner to the surface of the photosensitive drum 31 where the electrostatic image has been formed. The developing unit 34 is provided with a rotary rack 341, and a plurality of developers 34Y, 34M, 34C, 34K. The rotary rack 341 is rotated about its rotational axis 340 by a rotating unit (not shown in the figures), and carries out developing by moving the plurality of developers 34Y, 34M, 34C, 34K in sequence to the developing position against the photosensitive drum. The yellow developer 34Y, magenta developer 34M, cyan developer 34C and black developer 34K are maintained in alignment in this order about the circumferential direction of the rotary rack 341. Further, these developers are disposed so that the interval between adjacent developers along the periphery is approximately 90 degrees.

The transferring unit 35 is for transferring the toner image on the photosensitive drum 31 to the recording medium, and is provided with an intermediate transfer belt 351, primary transfer rollers 352 and 353, a drive roller 355, a secondary transfer opposing roller 354, and a secondary transfer roller 356. The intermediate transfer belt 351 is endlessly wrapped around the primary transfer rollers 352 and 353, the drive roller 355, and the secondary transfer opposing roller 354, and is driven by the drive roller 355. The intermediate transfer belt 351 functions as a transfer body to which the toner image formed on the photosensitive drum 31 is transferred and temporarily held. The secondary transfer roller 356 is disposed to a position opposite the secondary transfer opposing roller 354 at the outer peripheral surface of the intermediate transfer belt 351, and function in the secondary transfer of the toner image to the recording medium.

The cleaning blade 36 is for cleaning adherents such as leftover developing agent that remains on the photosensitive drum 31. For example, a urethane rubber with a hardness of 77° is pressed into contact with the photosensitive drum.

The roller 37 comes into contact with the surface of the photosensitive drum 31, and functions as a buffer which recovers or blows off toner. The roller 37 is formed by covering the circumference of a metal shaft with foaming rubber, and is biased at 9.8 N (each side: 4.9 N) toward the photosensitive drum 31 by springs (not shown in the figures). In addition, the roller 37 is in contact with the photosensitive drum 31 and has a surface speed during rotation that is 1.2 times that of the surface speed of the drum.

As shown in FIG. 8, the fixing unit 38 is formed of a fixing roller (heat roller) 381 which is a fixing body disposed to be freely rotating; a pressure roller 382 which is a pressing body that rotates while pressing against the fixing roller 381. A heater 383 such as a halogen lamp or the like is disposed inside the fixing roller 381. In addition, a thermistor 384 is disposed so as to be in contact with the fixing roller 381 in order to measure its surface temperature. Based on the value measured with the thermistor 384, a temperature adjusting circuit carries out adjustment of the temperature of the surface of the fixing roller 381 by controlling the voltage of the heater 383. With this arrangement in place, when the conveyed recording medium 322 passes between the pressure roller 382 and the fixing roller 381 which is rotating at a fixed speed, the recording medium 322 is subjected to pressing and heating at a constant pressure and temperature on both its front and back surfaces. As a result, the unfixed toner image on the surface of the recording medium 322 is melted and fixed thereto. As a result, a full color image is formed on the recording medium 322.

The recording medium 322 to which the image has been fixed is separated from the fixing roller 381 with a separating claw (not shown), and expelled to the outside of the device.

As the fixing roller 381 that is employed in the above-described fixing unit 38, it is preferable to employ a design in which, for example, a material having superior releasability, thermal resistance, and wear resistance, such as a fluorinated resin or the like, is coated to the surface of an aluminum or other such metal pipe, forming an outer layer thereto. In the case where the image forming device is one in which image quality is particularly emphasized, such as a color copying machine that employs an electrophotography, it is preferable to employ silicon rubber as the outer layer of the roller in the fixing roller 381. However, silicon rubber has somewhat poorer releasability as compared to fluorinated resins, so that it is desirable to coat a silicon oil to the surface thereof as a releasing agent. Note that it is acceptable to employ a product in which a fluorinated resin sheet has been wrapped to a silicon rubber.

The pressure roller 382 is not particularly restricted, however, it is preferable to employ a silicon rubber roller having a solid metal rod as a core.

As shown in FIG. 8, the cooling unit 39 is provided with a first cooling roller 391 that is disposed to be freely rotating, and a second cooling roller 392 that is disposed opposite the first cooling roller 391. The cooling unit 39 rapidly cools the toner image that was heated by the fixing unit 38.

The first cooling roller 391 and the second cooling roller 392 form a pair. The first cooling roller 391 is in direct contact with the toner image on the recording medium 322, and cools the toner image from the surface layer side of the toner image. In contrast, the second cooling roller 392 is opposite the first cooling roller 391 and cools the toner image from beneath the toner image via the recording medium.

The surface temperature of the first cooling roller 391 is controlled to be greater than the surface temperature of the second cooling roller 392.

The combination of the first cooling roller 391 and the second cooling roller 392 may be referred to as a “roller pair” hereinafter.

When the heated toner image is cooled, the resin contained in the toner shrinks during the cooling process, and shrink marks can readily form on the surface of the image. In particular, when the toner image is gradually cooled, shrinkage of the resin can more readily occur. When a shrink mark forms, the smoothness of the image surface decreases and it becomes more difficult to obtain a high gloss image.

In addition, in the case where the toner image is cooled in the same way from both its top layer side and its bottom layer side via the recording medium, it takes longer time to cool the bottom layer side of the toner image since the thermal conductivity of the recording medium (paper) is typically less than the toner. As a result, there is a difference in the cooling rate between the top layer side and the bottom layer of the toner image. Namely, the cooling speed of the top layer side which is directly cooled is faster than the cooling speed of the bottom layer side which is cooled via the recording medium. Thus, there is a temperature difference between the top layer side and the bottom layer side of the toner image (i.e., the top layer side which is directly cooled has a lower temperature than the bottom layer side), and cracks occur more readily in the image surface. In order to control the occurrence of cracking, the speed of cooling of the toner image can be reduced. However, as discussed above, when the toner image is gradually cooled, shrinkage of the resin occurs more readily, making it difficult to obtain a high gloss image.

In contrast, by rapidly cooling the heated toner image using the cooling unit as described in the above-described embodiment, shrinkage of the resin included in the toner can be controlled. As a result, the smoothness of the image surface is improved, and a high gloss image can be obtained.

The surface temperature of the first cooling roller 391, which is in direct contact with the toner image and thereby cools it, is controlled to be higher than the surface temperature of the second cooling roller 392 which cools the toner image via the recording medium 322. Thus, the cooling speed at the bottom layer side of the toner image cooled by the second cooling roller 392 via the recording medium, and at the top layer side cooled by the first cooling roller 391 is substantially the same. As a result, even if the toner image is cooled from both the top layer side and the bottom layer side of the toner image, a temperature difference between the top layer side and the bottom layer side does not readily occur, thereby the occurrence of cracking can be controlled. In other words, even if the toner image cooling speed is not reduced more than necessary, the occurrence of cracking in the image surface can be controlled. As a result, it is possible to both limit cracking and obtain a high gloss image.

The first cooling roller 391 and the second cooling roller 392 will be explained in detail.

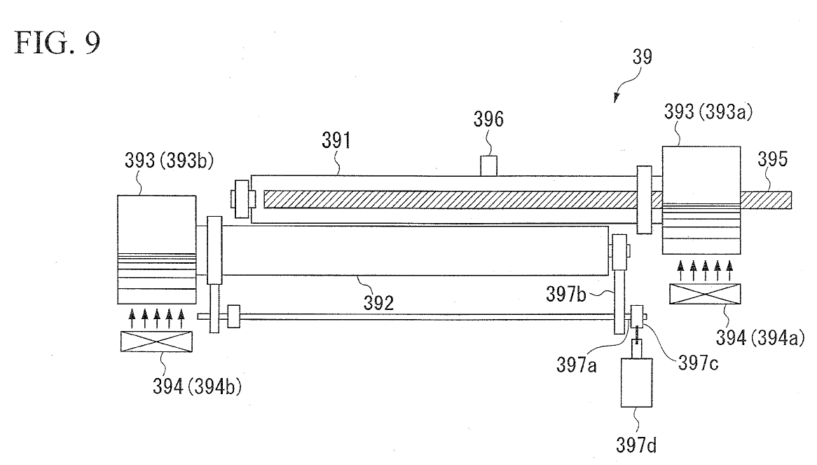

As shown in FIG. 9, the respective ends of the first cooling roller 391 and the second cooling roller 392 extend beyond the paper feeding region. One end of the first cooling roller 391 and the end of the second cooling roller 392 that is opposite the one end of the first cooling roller 391 are connected to respective radiator fins 393 (radiator fins 393a, 393b). Fans 394 (fans 394a, 394b) are provided directly below the radiator fins 393. Specifically, the second cooling roller 392 drives the fan 394b constantly, providing cooling to a constant temperature via the radiator fin 393b. Accordingly, even during continuous paper feeding, the temperature of the surface of the second cooling roller 392 can be maintained at the ambient temperature+around 3° C.

A heater 395 which is formed of heat generating conductive wire is housed inside the first cooling roller 391. In addition, a thermistor 396 for measuring the surface temperature is disposed inside the first cooling roller 391.

The ON/OFF control for the fan 394a which blows air on the radiator fin 393a on one end of the first cooling roller 391 can be carried out in response to the surface temperature that is detected by the thermistor 396. For example, when the surface temperature of the first cooling roller 391 that is detected by the thermistor 396 is less than a predetermined temperature that is set to be higher than the surface temperature of the second cooling roller 392, then the temperature of the first cooling roller 391 is increased to the predetermined temperature by conducting electricity through the heater 395. Further, the design provides that air does not come into contact with the radiator fin 393a that is connected to the end of the first cooling roller 391 at this time. Note that it is also acceptable to attach a thermistor to the second cooling roller 392 to measure its surface temperature, and to employ this surface temperature as a standard to determine whether or not to conduct electricity through the heater 394.

On the other hand, when the surface temperature of the first cooling roller 391 is higher than the predetermined temperature, then electricity is not conducted through the heater 395. The fan 394a is driven, so that air comes into contact with the radiator fin 393a and the first cooling roller 391 is cooled to the predetermined temperature.

As a result of the above structure, it is possible to adjust the temperature of the first cooling roller to a predetermined value. Further, the surface temperature of the first cooling roller 391 can be controlled to be higher than the surface temperature of the second cooling roller 392.

The surface temperature of the first cooling roller 391 is preferably controlled to be 5 to 35° C. higher, and more preferably 14 to 22° C., higher than the surface temperature of the second cooling roller 392. When the difference between the surface temperatures of the first cooling roller 391 and the second cooling roller 392 is 5° C. or less, then a difference occurs between the temperature of the top surface layer side and the bottom layer side of the toner during the cooling process, causing cracking in the image surface to occur. On the other hand, when the difference between the surface temperatures of the first cooling roller 391 and the second cooling roller 392 exceeds 35° C., while cracking can be controlled, the speed of cooling of the toner image by the first cooling roller 391 slows, so that glossiness tends to decline.

A heat pipe (made of copper), for example, may be preferably employed as the first cooling roller 391 and the second cooling roller 392. A heat pipe is superior with respect to thermal transmission, making it possible to rapidly cool the toner by means of direct contact with the toner image. However, since the adhesiveness between a copper heat pipe and the toner is low, in-plane variation of the cooling speed may occur. As a result, non-uniformity can readily occur in the obtained image. A PFA (copolymer of tetrafluoroethylene and perfluoralkoxyethylene) sheet is therefore adhered via a primer to the surface of the heat pipe. As a result, it is also possible to obtain releasability with the melted toner. The thickness of the PFA sheet is preferably on the order to 30 μm in the case of a heat pipe having an outer diameter of φ20 mm. In addition, it is also acceptable that silicon rubber is adhered in place of the PFA sheet.

The first cooling roller 391 and the second cooling roller 392 are in a separated state when the recording medium 322 is not passing between them, and are controlled so that they enter a state of pressure contact just before the front edge of the recording medium 322 reaches the pair of rollers. The timing for pressure contact the roller pairs to each other is calculated from the paper feed switch (not shown in the figures) that is provided to the transferring unit 35. The pressing force during the pressure contact state is typically 29.4 N (one side).

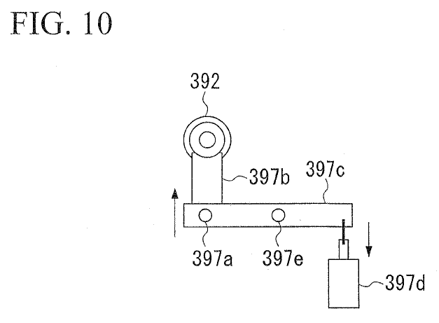

As shown in FIGS. 9 and 10, the second cooling roller 392 is connected to a solenoid 397d via a lifting bar 397b and an arm 397c, which are connected to one another by a connection bar 397a. As a result, the second cooling roller 392 is capable of vertical motion, so that it is possible to choose between a pressure contact state or a separated state. When the solenoid 397d is lowered accompanying the passage of the recording medium 322, the end of arm 397c which is on the side where the connection bar 397a is provided, rises centered about support point 397e. As a result, the second cooling roller 392 also rises coupled with this motion, and is pressed into contact with the first cooling roller 391 via the recording medium 322. When the recording medium 322 is relayed out from the pair of rollers, the solenoid 397d rises, and the end of the arm 397c which is on the side where the connection bar 397a is provided, lowers centered about the support point 397e. As a result, the second cooling roller 392 also lowers coupled with this motion, and is separated from the first cooling roller 391.

Typically, the recording medium 322 is interposed between the first cooling roller 391 and the second cooling roller 392 while the toner image is being cooled. Thus, heat does not readily transfer between the first cooling roller 391 and the second cooling roller 392, and the surface temperature of each of the rollers can easily be held constant. In contrast, the recording medium 322 is not interposed between the rollers when the toner image is not being cooled. As a result, if the first cooling roller 391 and the second cooling roller 392 are left in a state of pressed contact, transfer of heat between them occurs easily. When heat transfers, the difference in the surface temperature of the rollers becomes smaller. Thus, in order to maintain the surface temperature difference, more energy than necessary must be consumed in order to hold the surface temperature of each of the rollers constant so that the surface temperature of the first cooing roller 391 becomes higher than that of the second cooling roller 392.

However, by controlling the state of contact or separation between the first cooling roller 391 and the second cooling roller 392 as described in the present embodiment (i.e., by maintaining a state of separation when not cooling the toner image), it is possible to reduce the transfer of heat between the first cooling roller 391 and the second cooling roller 392 even when not cooling the toner image. As a result, energy consumption can be controlled.

It is preferable to dispose the roller pairs so that the distance 3d from the exit of the fixing nip part to the entrance of the cooling nip part is in the range of 10 to 50 mm.

As shown in FIG. 8, the term “fixing nip part” refers to the area of contact between the fixing roller 381 and the pressure roller 382 in the direction of conveyance of the recording medium 322. The exit of the fixing nip part refers to the end part 385 on the cooling unit 39 side of the fixing nip part. In contrast, as shown in FIG. 8, the term “cooling nip part” refers to the area of contact between the first cooling roller 391 and the second cooling roller 392 in the direction of conveyance of the recording medium 322. The entrance of the cooling nip part refers to the end part 398 on the fixing unit 38 side of the cooling nip part.

As shown in FIG. 8, temperature sensors 399 may be provided to the cooling unit 39 before and after the first cooling roller 391, so that the surface temperature of the toner image on the recording medium 322 can be measured before and after passing through the first cooling roller 391 and the second cooling roller 392.

A non-contact type thermometer may be employed as the temperature sensor 399.

By employing a pair of cooling rollers as described above, it is possible to cool the toner image without using air. As a result, the adjacent fixing unit 38 does not readily cool as compared to the case where air is employed. Accordingly, it is possible to limit energy consumption of the fixing unit 38, so that temperature deviations along the axial direction of the fixing roller 381 which is provided to the fixing unit 38 can be limited. In addition, there is little dispersion of warm air around the fixing unit 38 inside the image forming device. As a result, deterioration in the image due to changes in sensitivity of the photosensitive drum 31 or changes in the charge of the developing agent does not readily occur.

Next, the image forming method according to the present embodiment will now be explained using the image forming device 300 shown in FIG. 7.

First, charging of the photosensitive drum 31 using the charging unit 32 is carried out, after which the rotary rack 341 rotates about the rotational axis 340 provided at its center. The rotary rack 341 stops at the developing position, which is the position where the developer 34K, corresponding to black which is the first color, is opposite the photosensitive drum 31. Light exposure corresponding to black is then carried out by the exposing unit 33, and an electrostatic latent image corresponding to black is formed on the surface of the photosensitive drum 31. This electrostatic latent image then undergoes toner imaging by the developer 34K, and the toner image which is formed on the surface of the photosensitive drum 31 is transferred to the transfer belt 351 by the transfer bias which is applied on the primary transfer rollers 352 and 353.

When this formation of the black toner image to the transfer belt 351 is complete, the rotary rack 341 rotates around the rotational axis 340 provided at its center, and the developer 34C corresponding to cyan is positioned at the developing position. This operation is carried out for the other colors of cyan, magenta, and yellow respectively, to form the full color toner image on the transfer belt 35.

As described above, during the process of temporarily transferring the toner image to the intermediate transfer belt 351, the secondary transfer roller 356 separates from the transfer belt 351. In contrast, when the full color toner image is formed on the transfer belt 351, the secondary transfer roller 356 comes into contact with the transfer belt 351. At this time, by applying the secondary transfer bias with the secondary transfer roller 356, the full color toner image that is formed on the transfer belt 351 is transferred to the recording medium 322 which has been conveyed from the paper supplier 320 to the transfer position by the paper supply roller 321, etc., at a specific timing.

Next, the full color toner image transferred to the recording medium is fixed to the recording medium 322 by applying heat and pressure from the fixing unit as shown in FIG. 8. The heating temperature of the toner is acceptable provided that it is higher than the softening point of the toner. However, a temperature that is 25 to 45° C. higher than the softening point of the toner is preferable.

The toner image heated by the fixing unit 38 is rapidly cooled by the cooling unit 39. When rapidly cooling the toner image, it is preferable to rapidly cool the toner image from a temperature that is higher than the softening point of the toner, to a temperature that is lower than the softening point (i.e., it is preferable to carry out rapid cooling at temperatures near the toner softening point). Specifically, the cooling speed of the toner image near the softening point of the toner is preferably in the range of 150 to 250° C./sec.

It is acceptable to control the surface temperature of the first cooling roller 391 so as to be higher than the surface temperature of the second cooling roller 392, however a temperature in the range of 30 to 60° C. is preferred. On the other hand, maintaining the temperature of the second cooling roller 392 to be in the range of 20 to 30° C. is preferred.

When the recording medium 322 is not passing through the roller pairs, then the second cooling roller 392 is lowered and moves away from the first cooling roller 391 (i.e., enters the separated state). When the recording medium 322 is conveyed to the cooling unit 39, then the second cooling roller 392 rises accompanying the passage of the recording medium 322, and is pressed against the first cooling roller 391 (i.e., enters a state of pressed contact).

The recording medium 322 on which the toner image is cooled at the cooling unit 39 is discharged to the paper discharge unit 330 shown in FIG. 7.

The leftover developing agent that remains in the photosensitive drum 31 is cleaned by the cleaning blade 36, and is discarded in a waste toner container (not shown in the figures). The toner that remains in the transfer belt 351 is cleaned by bringing a cleaning device (not shown in the figures) for the transfer belt 351 into contact with the transfer belt 351 after the secondary transfer, and discarding the toner in the waste toner container (not shown in the figures). After the transfer belt 351 cleaning device has cleaned a portion of the transfer belt 351, it is separated from the transfer belt 351.

As explained above, by rapidly cooling the toner image in the above-described embodiment, it is possible to limit shrinkage of the resin included in the toner. As a result, smoothness of the image surface is improved and a high gloss image can be obtained.

The surface temperature of the first cooling roller 391, which is in direct contact with the toner image and thereby cools it, is controlled to be higher than the surface temperature of the second cooling roller 392 which cools the toner image via the recording medium 322. Thus, the cooling speed at the bottom layer side of the toner image cooled by the second cooling roller 392 via the recording medium 322, and the cooling speed at the top layer side cooled by the first cooling roller 391, are approximately the same. As a result, even if the toner image is cooled from both the top surface side and the bottom surface side of the toner image, a temperature difference between the top layer side and the bottom layer side does not readily occur, and the occurrence of cooling spots can be controlled. In other words, even if the toner image cooling speed is not reduced more than necessary, the occurrence of cracking in the image surface can be controlled. As a result, it is possible to both limit cracking and obtain a high gloss image.

The present invention also provides the essential vivid hues of deep colors, making it particularly ideal for color images.

In addition, when cooling the toner image, the recording medium (paper) is also cooled, so that the temperature of the discharged paper can be decreased.

In addition, the smoothness of the image surface can be improved, improving the stacking properties of the discharged paper.

In the present embodiment, the fixing unit that is adjacent to the cooling unit does not readily cool as compared to the case where air is employed in the cooling unit. Accordingly, the energy consumption of the fixing unit is controlled, and it is possible control the temperature variation along the axial direction of the fixing roller that is equipped to the fixing unit. In addition, there is little dispersion of the warm around the fixing unit within the image forming device, so that image deterioration due to changes in the sensitivity of the photosensitive drum or changes in the charge of the developing agent does not readily occur.

In general there is a tendency for the glossiness to increase if the amount of toner on the recording body is increased. However, the temperature difference between the top surface side and the bottom surface side of the toner image will increase due to thickening of the toner layer. As a result, cracking tends to occur more readily. However, in the present embodiment, cooling spots do not readily occur on the top layer side and the bottom layer side of the toner image, so that cracking does not readily occur even if the amount of toner increases. Accordingly, it is possible to both limit cracking and obtain a high gloss image.

The above-described third embodiment of the present invention will be concretely explained with examples.

### [Toner Production]

The toner employed in the present embodiment was produced in the same manner as in the example of the above-described first embodiment.

### EXAMPLES 13 to 17

### <Production of Image Forming Device>

For the image forming device, the design shown in FIGS. 7 to 10 was employed, and a previously obtained toner was housed in the developer container. Note that the design of the fixing unit 38 and the cooling unit 39 is as follows below.

### (Fixing Unit)

For the fixing roller 381, a design was employed in which 200 μm thick silicon rubber having a hardness of 5 (JIS-A) was coated to the surface of a 1.0 mm thick aluminum tube having an outer diameter of φ30 mm, after which a 30 μm thick PFA (a copolymer of tetrafluoroethylene and perfluoralkoxyethylene) tube was adhered via a primer to the surface of the above coated aluminum pipe. A halogen heat lamp 383 was disposed inside the fixing roller 381, and lighting of the lamp was controlled so that the surface temperature of the fixing roller was a constant 170° C. with use of a thermistor 384 that was in contact with the surface of the fixing roller 381.

For the pressure roller 382, a solid iron rod having a core with a outer diameter of φ18 mm was employed for the core of the silicon rubber having a thickness of 6 mm, a hardness of 5 (JIS-A) and an outer diameter of φ30 mm.

### (Cooling Unit)

The first cooling roller 391 and the second cooling roller 392 are disposed so that the distance 3d from the exit of the fixing nip part to the entrance of the cooling nip part was 30 mm (i.e., at a position 0.2 seconds downstream from the exit of the fixing nip part when the recording medium conveying speed is 150 mm/sec).

A design is employed for the first cooling roller 391 and the second cooling roller 392 in which a 30 μm thick PFA sheet is adhered via a primer to the surface of a cylindrical heat pipe (made of copper) which has an inner diameter of φ10 mm and an outer diameter φ20 mm.

### (Method for Controlling Temperature of First Cooling Roller)

The surface temperature of the first cooling roller 391 was detected with the thermistor 396. When the surface temperature of the first cooling roller 391 was lower than a predetermined temperature which is set so as to be higher than the surface temperature of the second cooling roller 392, electrical current was supplied to the heater 395, and the temperature of the first cooling roller 391 was raised to the predetermined temperature. In contrast, when the surface temperature of the first cooling roller 391 was higher than the predetermined temperature, electrical current was not supplied to the heater 395, the fan 394a was driven and the first cooling roller 391 was cooled to the predetermined temperature by blowing air onto the radiator fin 393a. In the same manner during both paper feeding and stand-by, the supply of current to the heater 395 and the driving of the fan 394a were controlled while observing the surface temperature of the first cooling roller 391, so that a constant temperature was always maintained.

Note that the surface temperature of the second cooling roller 392 was detected using a thermistor (not shown in figures) attached to the second cooling roller 392, and the second cooling roller 392 was maintained at 28° C. using the radiator fin 393b and the fan 394b.

The surface temperature of the first cooling roller 391 was controlled using the radiator fin 393a, fan 394a, and heater 395 as described above, so as to maintain the temperature at the values shown in Table 3.

### <Evaluation>

The above image forming device was employed and evaluation was carried out as follows based on the aforementioned temperature controlling method.

The surface temperature of the first cooling roller 391 was controlled so as to have the value shown in Table 3 in each of the various Examples. The amount of toner on the recording medium is set so as to have the value shown in Table 3, and image samples were captured while recording the surface temperature of the toner image before and after passing through the roller pairs (measurement interval: 38 mm=0.25 sec). Color copy paper with a weight of 90 g/m², manufactured by Mondi, was employed as the recording medium. The surface temperature of the toner image before passing through the roller pair was 140° C., and the surface temperature of the recording medium in the area where no toner image was formed was 93° C.

The image surface glossiness of the image sample and the presence or absence of cracking for the 200^{th} piece of printed paper are shown in Table 3. Glossiness and the presence/absence of cracking were determined as follows.

### (Glossiness)

The image surface glossiness of the image samples was measured using a gloss meter (Handy Gloss Checker IG-331, manufactured by Horiba Ltd., angle of incidence: 60°).

### (Presence/Absence of Cracking)

The presence or absence of cracking in the image surface was observed by visual inspection, and evaluated based on the following evaluation standards. Note that evaluation as “Good” or “Possible” is considered a passing evaluation.

| | |
|---|---|
| Good: | No cracking |
| Possible: | Slight cracking |
| Poor: | Clear Cracking present |

### (Comprehensive Evaluation)

Comprehensive evaluation using the results of the evaluation of glossiness and presence/absence of cracking was carried out based on the following standards. Note that “Excellent” and “Good” indicated a passing evaluation. “Excellent” satisfies all of the following requirements:
Result of evaluation for presence/absence of cracking is “good”
Glossiness for a toner quantity of 0.5 mg/cm² is 25 or more
Glossiness for a toner quantity of 1.5 mg/cm² is 35 or more “Good” does not fall into the above “Excellent” category or the below “Poor” category “Poor” satisfies any of the following:
Result of evaluation for presence/absence of cracking is “poor”
Glossiness for a toner quantity of 0.5 mg/cm² is less than 20
Glossiness for a toner quantity of 1.5 mg/cm² is less than 30

### Comparative Examples 4, 5

Image formation and evaluation were carried out in the same manner as in Examples 13 to 17, with the exception that the surface temperature of the first cooling roller 391 was controlled to have the value shown in Table 3, and the amount of toner on the recording medium was set to be the value shown in Table 3.

TABLE 3

| | Surface temp. of | Temp. difference with | Toner | | | |
|---|---|---|---|---|---|---|
| | first cooling roller | second cooling roller | quantity | | Presence/Absence | Comprehensive |
| | (° C.) | (° C.) | (mg/cm²) | Glossiness | of cracking | evaluation |
| Ex. 13 | 33.2 | 5.2 | 0.5 | 31 | good | good |
| | | | 1 | 30 | possible | |
| | | | 1.5 | 31 | possible | |
| Ex. 14 | 38.1 | 10.1 | 0.5 | 30 | good | good |
| | | | 1 | 42 | good | |
| | | | 1.5 | 30 | possible | |
| Ex. 15 | 42.8 | 14.8 | 0.5 | 28 | good | excellent |
| | | | 1 | 40 | good | |
| | | | 1.5 | 46 | good | |
| Ex. 16 | 49 | 21 | 0.5 | 28 | good | excellent |
| | | | 1 | 33 | good | |
| | | | 1.5 | 38 | good | |
| Ex. 17 | 60.9 | 32.9 | 0.5 | 20 | good | good |
| | | | 1 | 25 | good | |
| | | | 1.5 | 35 | good | |
| Comp. Ex. 4 | 28 | 0 | 0.5 | 25 | poor | poor |
| | | | 1 | 31 | poor | |
| | | | 1.5 | 31 | poor | |

| | | | | | |
|---|---|---|---|---|---|
| Comp. Ex. 5 | No first and second cooling rollers | 0.5 | 14 | good | poor |
| | | 1 | 20 | good | |
| | | 1.5 | 30 | good | |

As is clear from Table 3, the images obtained in these Examples have a higher glossiness and are less prone to the development of cracking as compared to the Comparative Examples. In particular, in Examples 15-17, in which the difference in temperature between the first cooling roller and the second cooling roller is large, cracking does not occur even if the amount of toner is increased.

In these Examples, by providing a difference in the surface temperatures of the first cooling roller and the second cooling roller, which corresponds to the temperature difference between the top layer side and the bottom layer side of the toner image, the cooling speed of the toner image overall is nearly constant. As a result, it is possible to control the generation of cracks in the image surface. Note that it is difficult to directly measure the temperature on the bottom layer side of the toner image. However, this temperature can be presumed from the surface temperature of the toner image and the surface temperature of the recording medium in the areas where the toner image is not formed.

In contrast, in Comparative Example 4, the surface temperature difference between the first cooling roller and the second cooling roller is 0° C., so that the top layer of the toner image cools more rapidly than the bottom layer, and cracking in the image surface occurs. However, since the effect of rapid cooling of the toner image was obtained, it is possible to obtain an image with a high gloss appearance on visual inspection. However, the glossiness of this Comparative Example was inferior to that of the Examples.

In Comparative Example 5, first and second cooling rollers were not provided. As a result, cracking did not occur as it was not the case that only the top layer side of the toner image cooled rapidly. However, because the toner cooled gradually, the resin contained in the toner shrunk and formed shrink marks on the image surface. As a result, the smoothness of the image surface was lost and the glossiness was reduced.

The image surface of the image samples obtained in the various Examples and Comparative Examples was inspected using a digital microscope (VHX-600, manufactured by Keyence Corp., 1000 to 2000 magnification). In the case of the Examples, this inspection revealed very slightly depressed spots. As the glossiness became greater, the size of the spots became smaller, with a finer interval and a shallower depth.

In contrast, in the Comparative Examples, this inspection revealed spots that were larger, with a wider interval and deeper depression, as compared to the Examples.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An image forming device comprising:
a fixing unit that fixes a toner image formed on a recording medium by heating the toner image to a temperature that is higher than the softening point of a toner that forms the toner image; and
a cooling unit that cools the fixed toner image from a temperature that is higher than the softening point of the toner, to a temperature that is lower than the softening point of the toner, at a predetermined cooling speed.

2. An image forming device according to claim 1, wherein the cooling speed is 150 to 250° C./sec.

3. An image forming device according to claim 1, wherein the cooling unit comprises a cooling roller.

4. An image forming device according to claim 3, wherein
the cooling unit comprises a first cooling roller that cools the toner image by contacting the toner image, and a second cooling roller that is opposite the first cooling roller; and
the surface temperature of the first cooling roller is controlled so as to be higher than the surface temperature of the second cooling roller.

5. An image forming device according to claim 4, wherein
the first cooling roller and the second cooling roller are controlled so as to be pressed into contact with each other or separated from each other; and
the first cooling roller and the second cooling roller are pressed into contact with each other when the recording medium passes between the first cooling roller and the second cooling roller, such that the recording medium is held therebetween.

6. An image forming device according to claim 1, wherein the cooling unit comprises a misting nozzle that sprays a liquid as a mist onto the toner image.

7. An image forming method comprising:
fixing a toner image formed on a recording medium by heating the toner image to a temperature that is higher than the softening point of a toner that forms the toner image; and
cooling the fixed toner image from a temperature that is higher than the softening point of the toner, to a temperature that is lower than the softening point of the toner, at a predetermined cooling speed.

8. An image forming method according to claim 7, wherein the cooling speed is 150 to 250° C./sec.

9. An image forming method according to claim 7, wherein
the fixed toner image is cooled by passing between a first cooling roller and a second cooling roller that is opposite the first cooling roller while being brought into contact with the first cooling roller; and
the surface temperature of the first cooling roller is controlled so as to be higher than the surface temperature of the second cooling roller.

10. An image forming method according to claim 9, wherein
the first cooling roller and the second cooling roller are controlled so as to be pressed into contact with each other or separated from each other; and
the first cooling roller and the second cooling roller are pressed into contact with each other when the recording medium passes between the first cooling roller and the second cooling roller, such that the recording medium is held therebetween.

11. An image forming method according to claim 7, further comprising cooling the toner image by spraying a liquid as a mist.
